(19) United States
(12) Patent Application Publication
(10) Pub. No.: US 2021/0278337 A1
(43) Pub. Date: Sep. 9, 2021

(54) EQUIVALENT FRICTION COEFFICIENT MEASUREMENT APPARATUS FOR ROLLING BEARINGS AND METHOD THEREOF

(71) Applicant: TIANJIN UNIVERSITY, TIANJIN (CN)

(72) Inventors: Chengzu REN, TIANJIN (CN); Chunlei HE, TIANJIN (CN); Chuanbin YAN, TIANJIN (CN); Guang CHEN, TIANJIN (CN); Xiang GE, TIANJIN (CN); Yang CHEN, TIANJIN (CN); Xinmin JIN, TIANJIN (CN)

(21) Appl. No.: 17/239,656

(22) Filed: Apr. 25, 2021

Related U.S. Application Data
(63) Continuation of application No. PCT/CN2019/113880, filed on Oct. 29, 2019.

(30) Foreign Application Priority Data
Oct. 31, 2018 (CN) 201811283076.4
Oct. 31, 2018 (CN) 201811283077.9
Oct. 31, 2018 (CN) 201811283092.3
Oct. 31, 2018 (CN) 201811283190.7

(51) Int. Cl. G01N 19/02

(52) U.S. Cl. CPC G01N 19/02

(57) ABSTRACT

Disclosed is an equivalent friction coefficient measurement apparatus for a rolling bearing. The apparatus comprises a machine body, a rotary shafting, a sliding seat, a rotational velocity sensor and a data acquisition/processing/calculation/display system. The rotary shafting comprises a mandrel and two support bearings supporting the mandrel. The support bearings are configured as air-floating spindle assemblies or measured rolling bearings or the air-floating spindle assembly and the measured rolling bearing. The rotational velocity sensor is configured to monitor an angular velocity of gyration of the mandrel. The data acquisition/processing/calculation/display system is configured to acquire and process the angular velocity of gyration signal of the mandrel monitored by the rotational velocity sensor, acquire a numerical relationship between the angular velocity of the mandrel and time under a condition of no power, and calculate a numerical relationship between the total kinetic energy of the rotary shafting and time.

### CROSS-REFERENCE TO RELATED APPLICATIONS

This application is a continuation of International Patent Application No. PCT/CN2019/113880 with a filing date of Oct. 29, 2019, designating the United States, now pending, and further claims priority to Chinese Patent Application No. 201811283077.9 with a filing date of Oct. 31, 2018, Chinese Patent Application No. 201811283076.4 with a filing date of Oct. 31, 2018, Chinese Patent Application No. 201811283190.7 with a filing date of Oct. 31, 2018, Chinese Patent Application No. 201811283092.3 with a filing date of Oct. 31, 2018. The content of the aforementioned applications, including any intervening amendments thereto, are incorporated herein by reference.

### TECHNICAL FIELD

The present disclosure relates to the technical field of friction energy consumption characteristics measurement of rolling bearings, and more specifically, to an equivalent friction coefficient measurement apparatus for a rolling bearing and method thereof.

### BACKGROUND

The friction energy consumption in the running process of a rolling bearing directly affects the heating, temperature rise and wear of the bearing, and then affects the performance and life of the rolling bearing. The friction energy consumption of rolling bearing is an inherent characteristic of rolling bearing. to some extent, which reflects the manufacturing quality and cleaning degree of the rolling bearing.

The starting friction torque and the rotational friction torque are respectively adopted to evaluate the starting friction energy consumption and the rotational friction power consumption of the rolling bearing currently, and each kind of friction torque measurement device is used to measure the starting friction torque and the rotational friction torque of rolling bearing.

Since the amplitudes of the starting friction torque and the rotating friction torque of the rolling bearing are small under the test conditions, the precision of the micro-force or micro-torque sensor used in the existing rolling bearing friction torque measuring device is obviously insufficient in the high-precision measurement. Therefore, it is necessary to develop a new measurement apparatus for measuring the friction energy consumption characteristics of rolling bearings.

### SUMMARY

In view of the above, the present disclosure provides an equivalent friction coefficient measurement apparatus for a rolling bearing and method thereof, the rolling bearing in the disclosure includes an angular contact ball bearing, a thrust ball bearings, a single row tapered roller bearing, a deep groove ball bearing or a cylindrical roller bearing.

The present disclosure provides an equivalent friction coefficient measurement apparatus for a rolling bearing, comprising: a machine body, a rotary shafting, a sliding seat, and a rotational velocity sensor and a data acquisition/processing/calculation/display system, wherein the rotary shafting comprises a mandrel and two support bearings supporting the mandrel, and the rotary shafting is installed between the machine body and the sliding seat; the two support bearings are configured as air-floating spindle assemblies or measured rolling bearings or the air-floating spindle assembly and the measured rolling bearing, wherein the air-floating spindle assembly comprises an air-floating spindle base and an air-floating spindle, and the rotary shafting further comprises the measured rolling bearing when the two support bearings supporting the mandrel are air-floating spindle assemblies; the measurement apparatus further comprises a power device and a clutch device, a output shaft of the power device is configured to connect to or separate from a free end of one of the air-floating bearing spindles through the clutch device when the two supporting bearings are air-floating spindle assemblies, or the output shaft of the power device is configured to connect to or separate from the mandrel through the clutch device when the two supporting bearings are measured rolling bearings, or the output shaft of the power device is configured to connect to or separate from the air-floating bearing spindle through the clutch device when the two supporting bearings are the air-floating spindle assembly and the measured rolling bearing; the rotational velocity sensor is configured to monitor a angular velocity of gyration of the mandrel; the data acquisition/processing/calculation/display system is configured to acquire and process the angular velocity of gyration signal of the mandrel monitored by the rotational velocity sensor, acquire a numerical relationship between the angular velocity of the mandrel and time under a condition of no power, and calculate a numerical relationship between the total kinetic energy of the rotary shafting and time, wherein a derivative with respect to time of the numerical relationship between the total kinetic energy of the rotary shafting and time at a certain moment is a friction power of the measured rolling bearing corresponding to the angular velocity at the certain moment; the data acquisition/processing/calculation/display system is configured to calculate and display an equivalent friction torque and the equivalent friction coefficient of the measured rolling bearing according to the relationship between the friction power and the equivalent frictional torque and the equivalent friction coefficient.

In a preferred embodiment, wherein the measured rolling bearing is an angular contact ball bearing, a thrust ball bearing or a single row tapered roller bearing, and the measured rolling bearing is abstracted as a virtual sliding bearing with a constant contact angle, and a sliding mating surface of the virtual sliding bearing is configured to pass through the center of a rolling element of the measured rolling bearing, that is, the contact angle of the virtual sliding bearing is configured to equal to the contact angle α of the measured rolling bearing, and the sliding mating surface of the virtual sliding bearing is configured to pass through the center of the rolling element of the measured rolling bearing, and an inner ring and an outer ring of the virtual sliding bearing form a sliding friction pair at the sliding mating surface; the friction power consumption of the sliding friction pair is equivalent to the friction power consumption of the measured rolling bearing when placing the virtual sliding bearing in the same measurement condition as the corresponding measured rolling bearing, and the friction power consumption of the sliding friction pair is equal to a product of a sliding friction torque of the sliding friction pair and the angular velocity of gyration of the virtual sliding bearing, wherein the sliding friction torque of the sliding friction pair is equal to a product of a radius R of a middle portion of the sliding mating surface, a normal load at the sliding mating surface and a friction coefficient of the sliding friction pair; the sliding friction torque of the sliding friction pair is referred as the equivalent friction torque of the measured rolling bearing, and the sliding friction coefficient of the sliding friction pair is referred as the equivalent friction coefficient of the measured rolling bearing.

In a preferred embodiment, wherein the measured rolling bearing is a deep groove ball bearing or a cylindrical roller bearing, and the measured rolling bearing is abstracted as a virtual journal sliding bearing with a sliding mating surface passing through the center of a rolling element of the measured rolling bearing, that is, the sliding mating surface of the virtual journal sliding bearing is configured to pass through the center of the rolling element of the measured rolling bearing, and an inner ring and an outer ring of the virtual journal sliding bearing form a sliding friction pair at the sliding mating surface; the friction power consumption of the sliding friction pair is equivalent to the friction power consumption of the measured rolling bearing when placing the virtual journal sliding bearing in the same measurement condition as the corresponding measured rolling bearing, and the friction power consumption of the sliding friction pair is equal to a product of a sliding friction torque of the sliding friction pair and the angular velocity of gyration of the virtual journal sliding bearing, wherein the sliding friction torque of the sliding friction pair is equal to a product of a radius R of a middle portion of the sliding mating surface, a normal load at the sliding mating surface and a friction coefficient of the sliding friction pair; the sliding friction torque of the sliding friction pair is referred as the equivalent friction torque of the measured rolling bearing, and the sliding friction coefficient of the sliding friction pair is referred as the equivalent friction coefficient of the measured rolling bearing.

In a preferred embodiment, wherein the measured rolling bearing is an angular contact ball bearing, a thrust ball bearing or a single row tapered roller bearing, one of the two support bearings supporting the mandrel is the air-floating spindle assembly, while the other one is the measured rolling bearing; the air-floating spindle base is fixedly connected with the machine body, and an end of the mandrel is connected with the air-floating spindle through a conical surface or a coupling; a measured rolling bearing mounting structure is arranged between the other end of the mandrel and the sliding seat, and the measured rolling bearing mounting structure comprises two different structure:

In one structure, wherein the measured rolling bearing mounting structure comprises a shaft shoulder arranged at the end of the mandrel for mounting an inner ring of the measured rolling bearing, and a bearing seat for mounting an outer ring of the measured rolling bearing is fixed on the sliding seat, wherein the bearing seat is provided with an inner cylindrical surface cooperating with an outer cylindrical surface of the outer ring of the measured rolling bearing and an outer ring retaining shoulder, and the inner cylindrical surface is coaxially arranged with the air-floating spindle, and the sliding seat is driven by an external force to translate axially along the air-floating spindle.

In structure two, wherein the measured rolling bearing mounting structure comprises a bearing seat arranged at a shaft shoulder of the end of the mandrel for mounting an outer ring of the measured rolling bearing, and the bearing seat is provided with an inner cylindrical surface and an outer ring retaining shoulder cooperating with an outer ring of the measured rolling bearing, wherein a loading shaft for mounting an inner ring of the measured rolling bearing is fixed on the sliding seat, the loading shaft is provided with an outer cylindrical surface and an inner ring shoulder cooperating with the inner cylindrical surface of the inner ring of the measured rolling bearing, and the outer cylindrical surface is coaxially arranged with the air-floating spindle, and the sliding seat is driven by an external force to translate axially along the air-floating spindle.

In a preferred embodiment, an equivalent friction coefficient measurement method for a rolling bearing is provided, comprising: the measurement apparatus of above, wherein the power device is arranged on one side of the machine body, and the output shaft of the power device is configured to connect to or separate from the free end of one of the air-floating spindle through the clutch device; an axial loading device is arranged on one side of the sliding seat, the measurement method further comprises:

S1: connecting one end of the mandrel with the air-floating spindle through the conical surface or the coupling, moving the sliding seat to mount the measured rolling bearing to the measured rolling bearing mounting structure arranged between the mandrel and the sliding seat; when the measured rolling bearing mounting structure is provided with structure one, mounting the inner ring of the measured rolling bearing to the shaft shoulder on the other end of the mandrel, and the outer ring of the measured rolling bearing to the outer ring retaining shoulder of the bearing seat; when the measured rolling bearing mounting structure is provided with structure two, mounting the bearing seat to the shaft shoulder of the other end of the mandrel, and the inner ring of the measured rolling bearing to an inner ring shoulder of the loading shaft, mounting the outer ring of the measured rolling bearing to the outer ring retaining shoulder of the bearing seat;

S2: according to the type and size of the measured rolling bearing, and the specifications for measuring the friction torque of rolling bearing, such as the National Standard of the People's Republic of China GB/T32562-2016 “Measuring Method for Friction Torque of Rolling Bearing”, applying a specified axial load to the outer ring of the measured rolling bearing through the sliding seat and the bearing seat by the axial loading device when the measured rolling bearing mounting structure is provided with structure one; or applying a specified axial load to the inner ring of the measured rolling bearing through the sliding seat and the loading shaft by the axial loading device when the measured rolling bearing mounting structure is provided with structure two;

S3: driving the air-floating spindle to rotate by the power device through the clutch device, keeping the air-floating spindle, the mandrel, the inner ring of the measured rolling bearing rotating synchronously when the measured rolling bearing mounting structure is provided with structure one, or keeping the air-floating spindle, the mandrel, the bearing seat and the outer ring of the measured rolling bearing rotating synchronously when the measured rolling bearing mounting structure is provided with structure two; acquiring and processing an angular velocity signal from the rotational velocity sensor of the mandrel, and calculating and displaying the angular velocity of the mandrel by the data acquisition/processing/calculation/display system;

S4: increasing a rotation velocity of the air-floating spindle and the mandrel to a given value gradually, separating the output shaft of the power device from the air-floating spindle by the clutch device after the rotation velocity is stabilized; gradually attenuating the rotation velocity of the mandrel under the action of the friction power consumption of the measured rolling bearing until the mandrel stops rotating; obtaining the numerical relationship between the angular velocity of the mandrel and time by the data acquisition/processing/calculation/display system;

S5: calculating a motion speed and kinetic energy of all moving parts on the rotary shafting by the data acquisition/processing/calculation/display system; obtaining a numerical relationship between the total kinetic energy of the rotary shafting and time; taking a derivative of the numerical relationship between the total kinetic energy of the rotary shafting and time, wherein the derivative with respect to time is a decreasing rate of the total kinetic energy at a certain moment, which is also the friction power of the measured rolling bearing at the corresponding angular velocity at the moment, and the quotient of the friction power of the measured rolling bearing divided by the angular velocity is the equivalent friction torque of the measured rolling bearing at the angular velocity; the quotient of the equivalent friction torque of the measured rolling bearing divided by the product of the radius R at the middle portion of the sliding mating surface of the virtual sliding bearing corresponding to the measured rolling bearing and the normal load at the sliding matching surface is the equivalent friction coefficient of the measured rolling bearing at the angular velocity; the normal load at the sliding matching surface is equivalent to the normal component of the axial load of the corresponding measured rolling at the sliding mating surface; when the angular velocity of the mandrel tends to zero, the corresponding equivalent friction torque and equivalent friction coefficient are equivalent to a starting equivalent friction torque and a starting equivalent friction coefficient of the measured rolling bearing.

In a preferred embodiment, for an angular contact ball bearing, or a single row tapered roller bearing, the equivalent friction coefficient measurement apparatus for a rolling bearing provides another proposal, wherein the two support bearings supporting the mandrel are all measured rolling bearings and respectively referred to as measured rolling bearing A and measured rolling bearing B; two ends of the mandrel are respectively provided with a shaft shoulder for mounting the inner ring of the measured rolling bearing A and the measured rolling bearings B; and two bearing seats are arranged vertically, wherein one of the two bearing seats is fixedly connected to the machine body, and the other one is fixedly connected with the sliding seat; the two bearing seats are respectively provided with an outer ring shaft shoulder and an inner cylindrical surface for mounting the measured rolling bearing A and the measured rolling bearings B; the inner cylindrical surfaces of the two bearing seats are coaxially arranged, and axes of the inner cylindrical surfaces of the two bearing seats are perpendicular to a horizontal plane; and the sliding seat is driven by an external force to translate axially along the inner cylindrical surfaces of the bearing seats.

In a preferred embodiment, when adopting the equivalent friction coefficient measurement apparatus to measure the equivalent friction coefficient of an angular contact ball bearing, or a single row tapered roller bearing, the power device is arranged on one side of the machine body, and the output shaft of the power device is configured to connect to or separate from the mandrel through the clutch device; an axial loading device is arranged on one side of the sliding seat, wherein the rotary shafting comprises the mandrel, the inner ring of the measured rolling bearing A, the inner ring of the measured rolling bearing B, the rolling element of the measured rolling bearing A, the rolling element of the measured rolling bearing B, a cage of the measured rolling bearing A and a cage of the measured rolling bearing B; the measurement method further comprises:

S1: respectively mounting the inner ring of the measured rolling bearing A and the inner ring of the measured rolling bearing B to shaft shoulders on two ends of mandrel; moving the sliding seat to mount the outer ring of the measured rolling bearing A to an outer ring retaining shoulder fixedly connected to the machine body, and the outer ring of the measured rolling bearing B to the outer ring retaining shoulder of the bearing seat fixedly connected to the sliding seat;

S2: according to the type and size of the measured rolling bearing, and the specifications for measuring the friction torque of rolling bearing, such as the National Standard of the People's Republic of China GB/T32562-2016 “Measuring Method for Friction Torque of Rolling Bearing”, applying a specified axial load F 1 to the outer ring of the measured rolling bearing B through the sliding seat and the bearing seat fixedly connected to the sliding seat by the axial loading device;

S3: driving the mandrel to rotate by the power device through the clutch device, keeping the mandrel, the inner ring of the measured rolling bearing A and the inner ring of the measured rolling bearing B rotating synchronously; acquiring and processing an angular velocity signal from the rotational velocity sensor of the mandrel, and calculating and displaying the angular velocity of the mandrel by the data acquisition/processing/calculation/display system;

S4: increasing the rotation velocity of the mandrel to a given value gradually; separating the output shaft of the power device from the mandrel by the clutch device after the rotation velocity is stabilized; gradually attenuating the rotation velocity of the mandrel under the action of the friction power consumption of the measured rolling bearing A and the measured rolling bearing B until the mandrel stops rotating; obtaining the numerical relationship ω(t) between the angular velocity of the mandrel and time by the data acquisition/processing/calculation/display system;

S5: calculating a motion speed and kinetic energy of all moving parts on the rotary shafting by the data acquisition/processing/calculation/display system; obtaining a numerical relationship between the total kinetic energy of the rotary shafting and time; taking a derivative of the numerical relationship between the total kinetic energy of the rotary shafting and time, wherein the derivative with respect to time is a decreasing rate of the total kinetic energy at a certain moment t, which is also a sum of the friction powers of the measured rolling bearing A and the measured rolling bearing B at the corresponding angular velocity at the moment, thus obtaining a numerical relationship P₁(ω) of the sum of the friction powers of the measured rolling bearing A and the measured rolling bearing B and the angular velocity;

S6: respectively mounting the inner ring of the measured rolling bearing A and the inner ring of the measured rolling bearing B to shaft shoulders on two ends of mandrel; moving the sliding seat to mount the outer ring of the measured rolling bearing B to an outer ring retaining shoulder fixedly connected to the machine body, and the outer ring of the measured rolling bearing A to the outer ring retaining shoulder of the bearing seat fixedly connected to the sliding seat;

S7: according to the type and size of the measured rolling bearing, and the specifications for measuring the friction torque of rolling bearing, such as the National Standard of the People's Republic of China GB/T32562-2016 “Measuring Method for Friction Torque of Rolling Bearing”, applying a specified axial load F2 to the outer ring of the measured rolling bearing A through the sliding seat and the bearing seat fixedly connected to the sliding seat by the axial loading device;

S8: repeating the step S3, S4, S5, and obtaining the numerical relationship ω(t) between the angular velocity of the mandrel and the time, the numerical relationship between the total kinetic energy of the rotary shafting and time, and obtaining a numerical relationship P₂(ω) of the sum of the friction powers of the measured rolling bearing A and the measured rolling bearing B and the angular velocity by the data acquisition/processing/calculation/display system;

S9: the quotient of the friction power of the measured rolling bearing divided by a angular velocity of gyration of the measured rolling bearing is the equivalent friction torque of the measured rolling bearing at the angular velocity; the quotient of the equivalent friction torque of the measured rolling bearing divided by the product of the radius R at the middle portion of the sliding mating surface of the virtual sliding bearing corresponding to the measured rolling bearing and the normal load at the sliding matching surface is the equivalent friction coefficient of the measured rolling bearing at the angular velocity; the normal load at the sliding matching surface is equivalent to the normal component of an axial load of the corresponding measured rolling bearing at the sliding mating surface, which is a quotient of an axial load on the measured rolling bearing divided by the sine of a contact angle α of the measured rolling bearing; for different angular velocities ω₁, ω₂, ω₃ [symbol] , . . . , establishing a binary linear equations in accordance with the constitution of the sum of the friction power of the measured rolling bearing A and the measured rolling bearing B under two measuring conditions in a range of a measured angular velocity:

$$\{ \begin{matrix}\frac{{F}_{1} + G}{sin α} {μ}_{A} ( ω ) R ω + \frac{{F}_{1}}{sin α} {μ}_{B} ( ω ) R ω = {P}_{1} ( ω ) \\ \frac{{F}_{2}}{sin α} {μ}_{A} ( ω ) R ω + \frac{{F}_{2} + G}{sin α} {μ}_{B} ( ω ) R ω = {P}_{2} ( ω )\end{matrix} , ω = {ω}_{1 } {ω}_{2} {ω}_{3} …$$

wherein, a first term on a left side of the equal sign of the equations is the friction power of the measured rolling bearing A, a second term is the frictional power of the measured rolling bearing B, and G is the gravity of the mandrel, μ_{A}(ω) [symbol] μ_{B}(ω) is the numerical relationship between the equivalent friction coefficient and the angular velocity of measured rolling bearing A and measured rolling bearing B respectively; obtaining the numerical relationship between the equivalent friction coefficient and the angular velocity μ_{A}(ω), μ_{B}(ω) of measured rolling bearing A and measured rolling bearing B respectively by solving the binary linear equations above; in accordance with the mechanical relationship between the friction torque and the friction coefficient, when the axial load on the measured rolling bearing A and the measured rolling bearing A are F, numerical relationship M_{A}(ω), M_{B}(ω) between the equivalent friction torque and the angular velocity of the measured rolling bearing A and the measured rolling bearing B are respectively as follows:

$$\{ \begin{matrix}{M}_{A} ( ω ) = \frac{{μ}_{A} ( ω ) F R}{sin α} \\ {M}_{B} ( ω ) = \frac{{μ}_{B} ( ω ) F R}{sin α} \end{matrix} , ω = {ω}_{1 } {ω}_{2} {ω}_{3} …$$

when the angular velocity of the mandrel tends zero, the corresponding equivalent friction torque and equivalent friction coefficient are respectively equivalent to the starting equivalent friction torque and starting equivalent frictional coefficient of the measured rolling bearing A and the measured rolling bearing B.

In a preferred embodiment, for a deep groove ball bearing or a cylindrical roller bearing, the two support bearings supporting the mandrel are all the air-floating spindle assembly in the measurement apparatus, and the two air-floating spindles are coaxially arranged; one of the air-floating spindle bases is fixedly connected with the machine body, while the other one is fixedly connected with the sliding seat; both ends of the mandrel are respectively connected with the two air-floating spindles through a conical surface or a coupling, and the mandrel is coaxially arranged with the two air-floating spindles; the mandrel is provided with a shaft shoulder for mounting an inner ring of the measured rolling bearing, and the sliding seat is driven by an external force to translate axially along the air-floating spindle.

In a preferred embodiment, when adopting the equivalent friction coefficient measurement apparatus to measure the equivalent friction coefficient of a deep groove ball bearing or a cylindrical roller bearing, the output shaft of the power device is connected to or separated from a free end of one of the air-floating spindles through the clutch device, and a radial loading device is arranged radially along the measured rolling bearing; wherein the rotary shafting comprises the two air-floating spindles, the mandrel, an inner ring of the measured rolling bearing, a rolling element and a cage of the measured rolling bearing; the measurement method further comprises:

S1: mounting the inner ring of the measured rolling bearing on the shaft shoulder of the mandrel; connecting the both ends of the mandrel to the two air-floating spindles respectively through the conical surface or the coupling;

S2: according to the type and size of the measured rolling bearing, and the specifications for measuring the friction torque of rolling bearing, such as the National Standard of the People's Republic of China GB/T32562-2016 “Measuring Method for Friction Torque of Rolling Bearing”, applying a specified radial load to the outer ring of the measured rolling bearing through the radial loading device;

S3: driving the mandrel to rotate by the power device through the clutch device; keeping the air-floating spindle, the mandrel and the inner ring of the measured rolling bearing rotating synchronously; acquiring and processing an angular velocity signal from the rotational velocity sensor of the mandrel, and calculating and displaying the angular velocity of the mandrel by the data acquisition/processing/calculation/display system;

S4: increasing the rotation velocity of the air-floating spindle and the mandrel to a given value gradually; separating the output shaft of the power device from the air-floating by the clutch device after the rotation velocity is stabilized; gradually attenuating the rotation velocity of the mandrel under the action of the friction power consumption of the measured rolling bearing until the mandrel stops rotating; obtaining the numerical relationship between the angular velocity of the mandrel and the time by the data acquisition/processing/calculation/display system.

S5: calculating a motion speed and kinetic energy of all moving parts on the rotary shafting by the data acquisition/processing/calculation/display system; obtaining a numerical relationship between the total kinetic energy of the rotary shafting and time; taking a derivative of the numerical relationship between the total kinetic energy of the rotary shafting and time, wherein the derivative with respect to time is a decreasing rate of the total kinetic energy at a certain moment, which is also the friction power of the measured rolling bearing at the corresponding angular velocity at the moment, and the quotient of the friction power of the measured rolling bearing divided by the angular velocity is the equivalent friction torque of the measured rolling bearing at the angular velocity; the quotient of the equivalent friction torque of the measured rolling bearing divided by the product of the radius R at the sliding mating surface of a virtual journal sliding bearing corresponding to the measured rolling bearing and the radial load at the sliding matching surface is the equivalent friction coefficient of the measured rolling bearing at the angular velocity; when the angular velocity of the mandrel tends to zero, the corresponding equivalent friction torque and equivalent friction coefficient are equivalent to a starting equivalent friction torque and a starting equivalent friction coefficient of the measured rolling bearing.

In a preferred embodiment, for a deep groove ball bearing or a cylindrical roller bearing, the two support bearings supporting the mandrel are all measured rolling bearings and respectively referred to as measured rolling bearing A and measured rolling bearing B; two ends of the mandrel are respectively provided with a shaft shoulder for mounting the inner ring of the measured rolling bearing A and the measured rolling bearings B; two bearing seats, wherein one of the two bearing seats is fixedly connected to the machine body, and the other one is fixedly connected with the sliding seat; the two bearing seats are respectively provided with an inner cylindrical surface cooperating with an outer cylindrical surface of the outer ring of the measured rolling bearing A and the measured rolling bearings B; the two bearing seats are arranged horizontally; the inner cylindrical surfaces of the two bearing seats are coaxially arranged; and the axes of the inner cylindrical surfaces of the two seats are parallel to a horizontal plane; the mandrel is provided with a ring-shaped counterweight; the sliding seat is driven by an external force to translate axially along the inner cylindrical surfaces of the bearing seats.

In a preferred embodiment, when adopting the equivalent friction coefficient measurement apparatus to measure the equivalent friction coefficient of a deep groove ball bearing or a cylindrical roller bearing, the output shaft of the power device is configured to connect to or separate from a free end of the mandrel through the clutch device; wherein the rotary shafting comprises the mandrel, the inner ring of the measured rolling bearing A, the inner ring of the measured rolling bearing B, the rolling element of the measured rolling bearing A, the rolling element of the measured rolling bearing B, a cage of the measured rolling bearing A, a cage of the measured rolling bearing B and the ring-shaped counterweight; the measurement method further comprises:

S1: respectively mounting the inner ring of the measured rolling bearing A and the inner ring of the measured rolling bearing B to shaft shoulders on two ends of mandrel; moving the sliding seat to mount the outer ring of the measured rolling bearing A and the measured rolling bearing B to the inner cylindrical surface of the two bearing seats;

S2: adjusting a mass and an axial position on the mandrel of the ring-shaped counterweight according to the type and size of the measured rolling bearing, wherein the radial support reaction of the measured rolling bearing A and the measured rolling bearing B are F_{1A} and F_{1B} respectively and meet the requirements of the friction torque measurement specification of the rolling bearing for applying radial load, such as the National Standard of the People's Republic of China GB/T32562-2016 “Measuring Method for Friction Torque of Rolling Bearing”;

S3: driving the mandrel to rotate by the power device through the clutch device, keeping the mandrel, the inner ring of the measured rolling bearing A, the inner ring of the measured rolling bearing B and the ring-shaped counterweight rotating synchronously; acquiring and processing an angular velocity signal from the rotational velocity sensor of the mandrel, and calculating and displaying the angular velocity of the mandrel by the data acquisition/processing/calculation/display system;

S4: increasing the rotation velocity of the mandrel to a given value gradually; separating the output shaft of the power device from the mandrel by the clutch device after the rotation velocity is stabilized; gradually attenuating the rotation velocity of the mandrel under the action of the friction power consumption of the measured rolling bearing A and the measured rolling bearing B until the mandrel stops rotating; obtaining the numerical relationship ω(t) between the angular velocity of the mandrel and time by the data acquisition/processing/calculation/display system;

S5: calculating a motion speed and kinetic energy of all moving parts on the rotary shafting by the data acquisition/processing/calculation/display system; obtaining a numerical relationship between the total kinetic energy of the rotary shafting and time; taking a derivative of the numerical relationship between the total kinetic energy of the rotary shafting and time, wherein the derivative with respect to time is a decreasing rate of the total kinetic energy at a certain moment, which is also the friction powers of the measured rolling bearing at the corresponding angular velocity at the moment, thus obtaining a numerical relationship P₁(ω) of the sum of the friction powers of the measured rolling bearing A and the measured rolling bearing B and the angular velocity;

S6: adjusting a mass and an axial position on the mandrel of the ring-shaped counterweight according to the type and size of the measured rolling bearing, wherein the radial support reaction of the measured rolling bearing A and the measured rolling bearing B are F_{2A} and F_{2B} respectively and meet the requirements of the friction torque measurement specification of the rolling bearing for applying radial load, such as the National Standard of the People's Republic of China GB/T32562-2016 “Measuring Method for Friction Torque of Rolling Bearing”, wherein the F_{2A}, F_{2B} and F_{1A}, F_{1B} are linearly independent;

S7: repeating the step S3, S4, S5, and obtaining the numerical relationship ω(t) between the angular velocity of the mandrel and the time in real time, the numerical relationship between the total kinetic energy of the rotary shafting and time, and obtaining a numerical relationship P₂(ω) of the sum of the friction powers of the measured rolling bearing A and the measured rolling bearing B and the angular velocity by the data acquisition/processing/calculation/display system;

S8: the quotient of the friction power of the measured rolling bearing divided by a angular velocity of gyration of the measured rolling bearing is the equivalent friction torque of the measured rolling bearing at the angular velocity; the quotient of the equivalent friction torque of the measured rolling bearing divided by the product of the radius R of the sliding mating surface of the virtual journal sliding bearing corresponding to the measured rolling bearing and the radial load at the sliding matching surface is the equivalent friction coefficient of the measured rolling bearing at the angular velocity; the radial load at the sliding matching surface is equivalent to the radial support reaction of the measured rolling bearing; for different angular velocities ω₁, ω₂, ω₃ [symbol] . . . , establishing a binary linear equations in accordance with the constitution of the sum of the friction power of the measured rolling bearing A and the measured rolling bearing B under two measuring conditions in a range of a measured angular velocity:

$$\{ \begin{matrix}{F}_{1 A} {μ}_{A} ( ω ) R ω + {F}_{1 B} {μ}_{B} ( ω ) R ω = {P}_{1} ( ω ) \\ {F}_{2 A} {μ}_{A} ( ω ) R ω + {F}_{2 B} {μ}_{B} ( ω ) R ω = {P}_{2} ( ω )\end{matrix} , ω = {ω}_{1 } {ω}_{2} {ω}_{3} …$$

wherein, a first term on a left side of the equal sign of the equations is the friction power of the measured rolling bearing A, a second term is the frictional power of the measured rolling bearing B, and μ_{A}(ω) [symbol] μ_{B}(ω) is the numerical relationship between the equivalent friction coefficient and the angular velocity of measured rolling bearing A and measured rolling bearing B respectively; obtaining the numerical relationship between the equivalent friction coefficient and the angular velocity μ_{A}(ω), μ_{B}(ω) of measured rolling bearing A and measured rolling bearing B respectively by solving the binary linear equations above; in accordance with the mechanical relationship between the friction torque and the friction coefficient, when the radial load on the measured rolling bearing A and the measured rolling bearing A are F, numerical relationship M_{A}(ω) M_{B}(ω) between the equivalent friction torque and the angular velocity of the measured rolling bearing A and the measured rolling bearing B are respectively as follows:

$$\{ \begin{matrix}{M}_{A} ( ω ) = {μ}_{A} ( ω ) F R \\ {M}_{B} ( ω ) = {μ}_{B} ( ω ) F R\end{matrix} , ω = {ω}_{1 } {ω}_{2} {ω}_{3} …$$

when the angular velocity of the mandrel tends zero, the corresponding equivalent friction torque and equivalent friction coefficient are respectively equivalent to the starting equivalent friction torque and starting equivalent frictional coefficient of the measured rolling bearing A and the measured rolling bearing B.

Compared with the prior art, the disclosure has the following beneficial effects.

On the one hand, the angular velocity measurement accuracy of the rotational speed sensor is much higher than that of the micro force or micro force distance sensor used in the conventional rolling bearing friction torque measurement device; on the other hand, all moving parts on the rotary shafting have a regular geometry, known highly accurate dimensions and masses, a definite motion mode and an accurate motion speed, so that the total kinetic energy of the rotating shafting system has a high calculation accuracy, therefore, the equivalent friction torque and the equivalent coefficient of friction of the rolling bearing to be measured have extremely high measuring and calculating precision.

Furthermore, the present disclosure could also increase the initial kinetic energy of the rotary shafting and extend the attenuation time of the angular velocity of the rotary shafting by increasing the mass of the moving parts on the rotary shafting, the measurement precision of the angular velocity of the rotary shafting is further improved, and the measurement and calculation precision of equivalent friction torque and equivalent friction coefficient of the measured rolling bearing are further improved.

### BRIEF DESCRIPTION OF THE DRAWINGS

FIG. 1-1 is a schematic structural diagram of a measured angular contact ball bearing;

FIG. 1-2 is a schematic diagram of a virtual sliding bearing corresponding to the angular contact ball bearing shown in FIG. 1-1;

FIG. 2-1 is a schematic structural diagram of a measured thrust ball bearing;

FIG. 2-2 is a schematic diagram of a virtual sliding bearing corresponding to the thrust ball bearing shown in FIG. 2-1;

FIG. 3-1 is a schematic structural diagram of a measured single row tapered roller bearing;

FIG. 3-2 is a schematic diagram of a virtual sliding bearing corresponding to the single row tapered roller bearing shown in FIG. 3-1;

FIG. 4-1 is a schematic structural diagram of a measured deep groove ball bearing;

FIG. 4-2 is a schematic diagram of a virtual sliding bearing corresponding to the deep groove ball bearing shown in FIG. 4-1;

FIG. 5-1 is a schematic structural diagram of a measured cylindrical roller bearing;

FIG. 5-2 is a schematic diagram of a virtual sliding bearing corresponding to the cylindrical roller bearing shown in FIG. 5-1;

FIG. 6 is a schematic partial structure and measuring principle diagram of a rolling bearing equivalent friction coefficient measuring apparatus according to embodiment 1;

FIG. 7 is a schematic partial structure and measuring principle diagram of a rolling bearing equivalent friction coefficient measuring apparatus according to embodiment 2;

FIG. 8 is a schematic partial structure and measuring principle diagram of a rolling bearing equivalent friction coefficient measuring apparatus according to embodiment 3;

FIG. 9 is a schematic partial structure and measuring principle diagram of a rolling bearing equivalent friction coefficient measuring apparatus according to embodiment 4;

FIG. 10 is a schematic partial structure and measuring principle diagram of a rolling bearing equivalent friction coefficient measuring apparatus according to embodiment 5.

In the Drawings,

inner ring 1; outer ring 2; rolling element 3; inner ring of a virtual sliding bearing 4; outer ring of a virtual sliding bearing 5; inner ring of a radial virtual sliding bearing 6; outer ring of a radial virtual sliding bearing 7; sliding mating surface 8; machine body 9; sliding seat 10; air-floating spindle base 11; air-floating spindle 12; mandrel 13; shaft shoulder 14; bearing seat 15; inner cylindrical surface 16; outer ring retaining shoulder 17; loading shaft 18; outer cylindrical surface 19; inner ring shoulder 20; ring-shaped counterweight 21; measured rolling bearing A 22; measured rolling bearing B 23.

### DETAILED DESCRIPTION OF EMBODIMENTS

The disclosure is further described below in combination with specific embodiments, not as a limitation to its scope of protection.

To avoid duplication, the raw materials involved in the embodiments are uniformly described as follows and are not given unnecessary details in the particular embodiments.

The measured rolling bearing in the present disclosure comprises deep groove ball bearings, cylindrical roller bearings, angular contact ball bearings, thrust ball bearings, or single row tapered roller bearings.

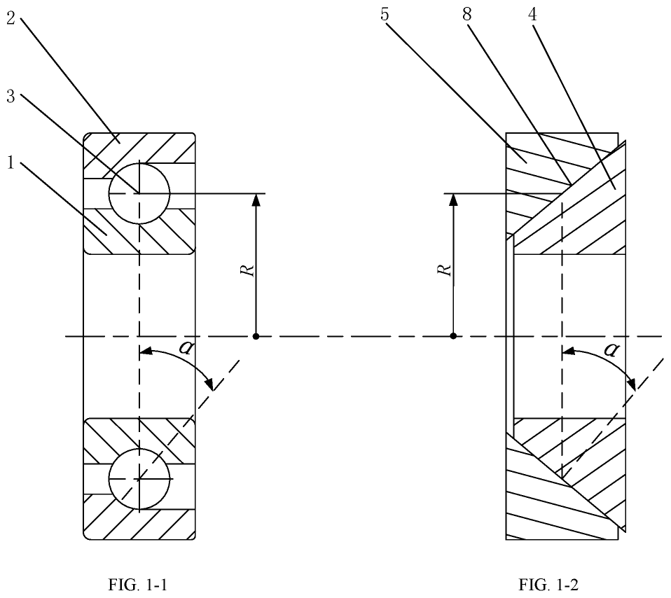

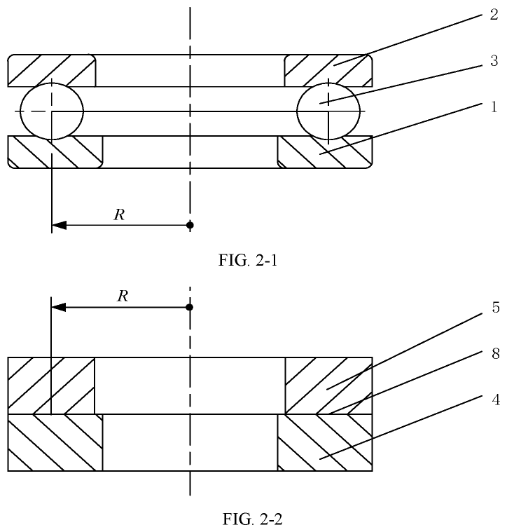

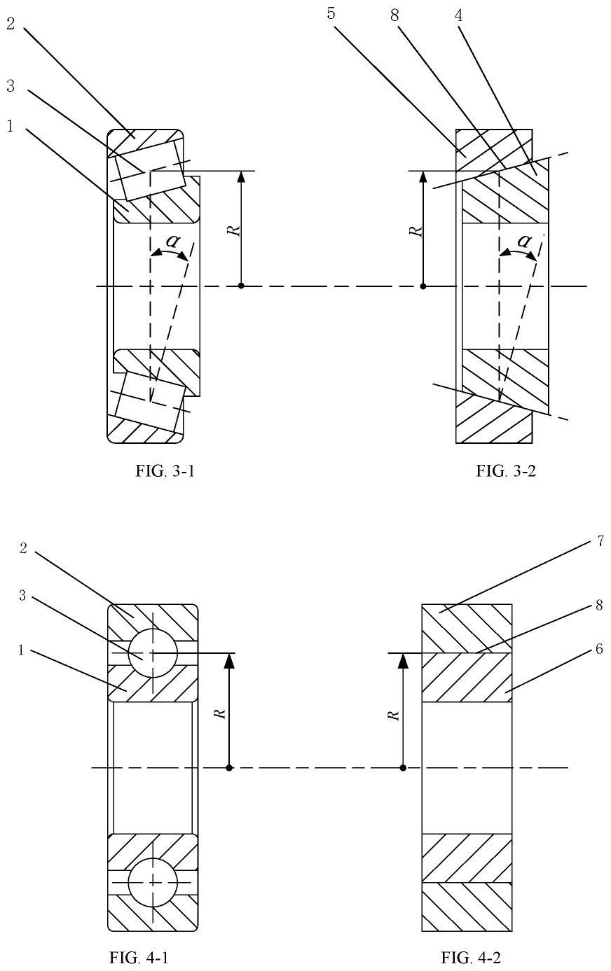

FIG. 1-1 shows a structure of an angular contact ball bearing, FIG. 2-1 shows a structure of a thrust ball bearing and FIG. 3-1 shows a structure of a single row tapered roller bearing; in the present disclosure, the measured rolling bearing is abstracted as a virtual sliding bearing with a constant contact angle, and a sliding mating surface 8 of the virtual sliding bearing is configured to pass through the center of a rolling element 3 of the measured rolling bearing, that is, the contact angle of the virtual sliding bearing is configured to equal to the contact angle α of the measured rolling bearing, and the sliding mating surface 8 of the virtual sliding bearing is configured to pass through the center of the rolling element 3 of the measured rolling bearing, FIG. 1-2 shows the virtual sliding bearing corresponding to the measured angular contact ball bearing shown in FIG. 1-1, FIG. 2-2 shows the virtual sliding bearing corresponding to the measured thrust ball bearing shown in FIG. 2-1, FIG. 3-2 shows the virtual sliding bearing corresponding to the measured single row tapered roller bearing shown in FIG. 3-1, and an inner ring 4 and an outer ring 5 of the virtual sliding bearing form a sliding friction pair at the sliding mating surface 8; the friction power consumption of the sliding friction pair is equivalent to the friction power consumption of the measured rolling bearing when placing the virtual sliding bearing in the same measurement condition as the corresponding measured rolling bearing, and the friction power consumption of the sliding friction pair is equal to a product of a sliding friction torque of the sliding friction pair and the angular velocity of gyration of the virtual sliding bearing, wherein the sliding friction torque of the sliding friction pair is equal to a product of a radius R of a middle portion of the sliding mating surface 8, a normal load at the sliding mating surface 8 and a friction coefficient of the sliding friction pair; the sliding friction torque of the sliding friction pair is referred as the equivalent friction torque of the measured rolling bearing, and the sliding friction coefficient of the sliding friction pair is referred as the equivalent friction coefficient of the measured rolling bearing.

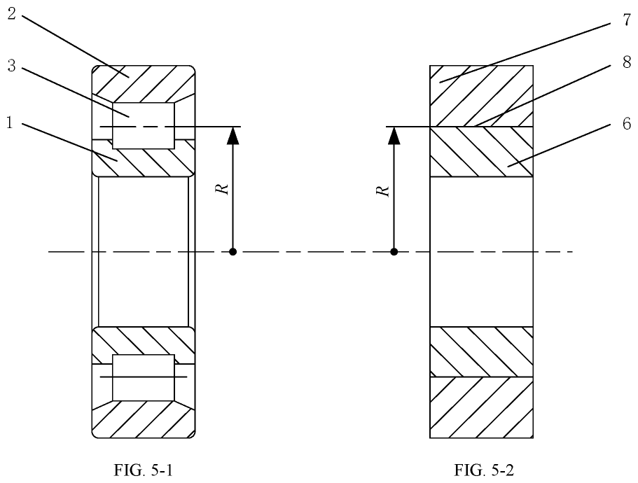

FIG. 4-1 shows the structural of the measured deep groove ball bearing, FIG. 5-1 shows the structural of the measured cylindrical roller bearing; in the present disclosure, the measured rolling bearing is abstracted as a virtual journal sliding bearing with the sliding mating surface 8 passing through the center of the rolling element 3 of the measured rolling bearing, that is, the sliding mating surface 8 of the virtual journal sliding bearing is configured to pass through the center of the rolling element 3 of the measured rolling bearing, FIG. 4-2 shows the virtual sliding bearing corresponding to the measured deep groove ball bearing shown in FIG. 4-1, FIG. 5-2 shows the virtual sliding bearing corresponding to the measured cylindrical roller bearing shown in FIG. 5-1, and an inner ring 6 and an outer ring 7 of the virtual journal sliding bearing form a sliding friction pair at the sliding mating surface 8; the friction power consumption of the sliding friction pair is equivalent to the friction power consumption of the measured rolling bearing when placing the virtual journal sliding bearing in the same measurement condition as the corresponding measured rolling bearing, and the friction power consumption of the sliding friction pair is equal to a product of a sliding friction torque of the sliding friction pair and the angular velocity of gyration of the virtual journal sliding bearing, wherein the sliding friction torque of the sliding friction pair is equal to a product of a radius R of a middle portion of the sliding mating surface 8, a normal load at the sliding mating surface 8 and a friction coefficient of the sliding friction pair; the sliding friction torque of the sliding friction pair is referred as the equivalent friction torque of the measured rolling bearing, and the sliding friction coefficient of the sliding friction pair is referred as the equivalent friction coefficient of the measured rolling bearing.

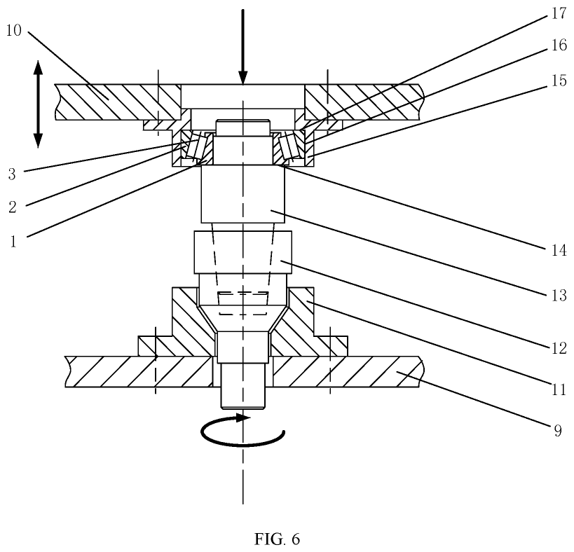

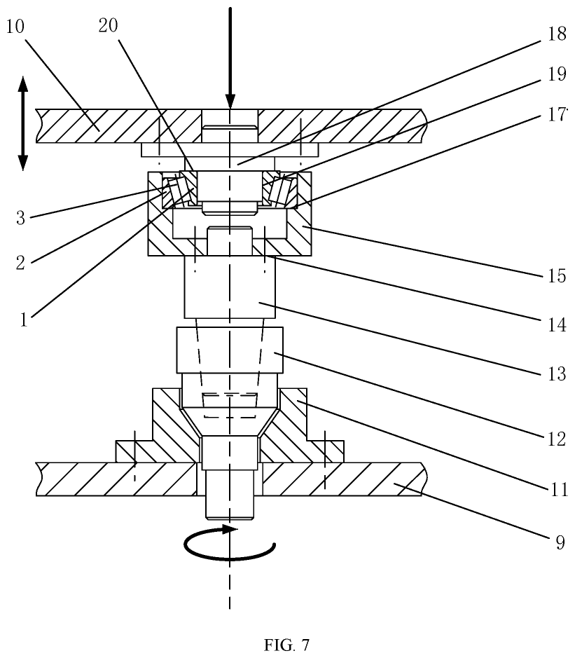

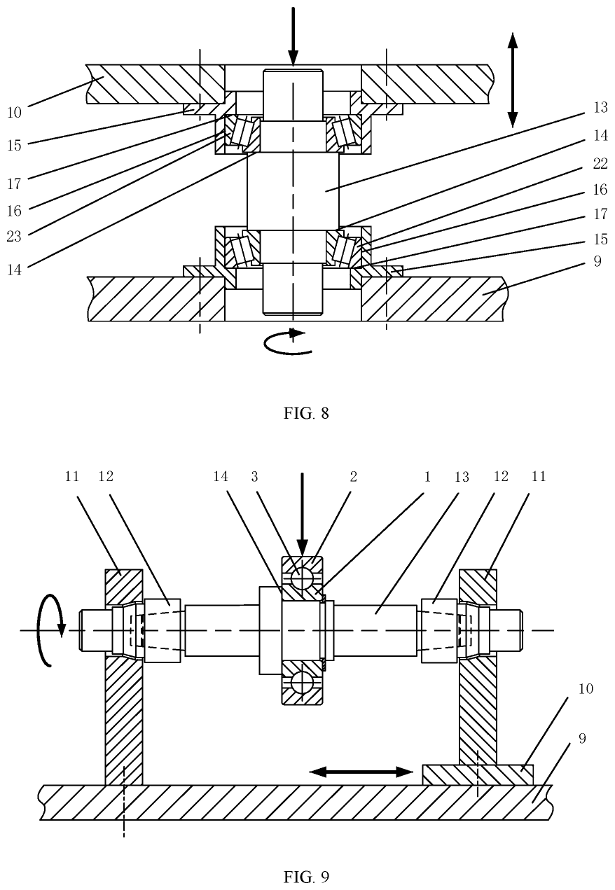

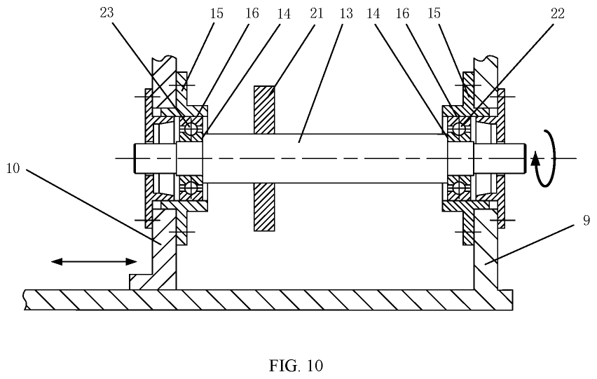

The equivalent friction coefficient measurement apparatus for rolling bearings presented in the disclosure, as shown in FIG. 6, FIG. 7, FIG. 8, FIG. 9 and FIG. 10, comprises a machine body 9, rotary shafting, a sliding seat 10, a rotational velocity sensor and a data acquisition/processing/calculation/display system, wherein the rotary shafting comprises a mandrel 13 and two support bearings supporting the mandrel 13, and the rotary shafting is installed between the machine body 9 and the sliding seat 10; the two support bearings are configured as air-floating spindle assemblies or measured rolling bearings or the air-floating spindle assembly and the measured rolling bearing, wherein the air-floating spindle assembly comprises an air-floating spindle base 11 and an air-floating spindle 12, and the rotary shafting further comprises the measured rolling bearing when the two support bearings supporting the mandrel 13 are air-floating spindle assemblies; the measurement apparatus further comprises a power device and a clutch device, a output shaft of the power device is configured to connect to or separate from a free end of one of the air-floating spindles 12 through the clutch device when the two supporting bearings are air-floating spindle assemblies, or the output shaft of the power device is configured to connect to or separate from the mandrel 13 through the clutch device when the two supporting bearings are measured rolling bearings, or the output shaft of the power device is configured to connect to or separate from the air-floating bearing spindle 12 through the clutch device when the two supporting bearings are the air-floating spindle assembly and the measured rolling bearing; the rotational velocity sensor is configured to monitor a angular velocity of gyration of the mandrel 13; the data acquisition/processing/calculation/display system is configured to acquire and process the angular velocity of gyration signal of the mandrel monitored by the rotational velocity sensor, acquire a numerical relationship between the angular velocity of the mandrel and time under a condition of no power, and calculate a numerical relationship between the total kinetic energy of the rotary shafting and time, wherein a derivative with respect to time of the numerical relationship between the total kinetic energy of the rotary shafting and time at a certain moment is a friction power of the measured rolling bearing corresponding to the angular velocity at the certain moment; the data acquisition/processing/calculation/display system is configured to calculate and display an equivalent friction torque and the equivalent friction coefficient of the measured rolling bearing according to the relationship between the friction power and the equivalent frictional torque and the equivalent friction coefficient.

### Embodiment 1 of the Measurement Apparatus

FIG. 6 shows a structure of embodiment 1 of a rolling bearing equivalent friction coefficient measurement apparatus which is suitable for measurement of equivalent friction coefficients of angular contact ball bearings, thrust ball bearings or single row tapered roller bearings according to the present invention, the measurement apparatus comprises the machine body 9, the rotary shafting, the sliding seat 10, the rotational velocity sensor (not shown in the figure) and the data acquisition/processing/calculation/display system (not shown in FIG.). The rotary system comprises the mandrel 13 and support bearings supporting the mandrel 13, and the rotary shafting is installed between the machine body 9 and the sliding seat 10, wherein one of the two support bearings supporting the mandrel 13 is the air-floating spindle assembly, while the other one is the measured rolling bearing.

The air-floating spindle assembly includes the air-floating spindle base 11 and the air-floating spindle 12, and the air-floating spindle base 11 is fixed to the machine body 9. The connecting end of the mandrel 13 is connected with the air-floating spindle 12 through a conical surface (or connected with the air-floating spindle 12 through a coupling), to ensure that that the air-floating spindle 12 and the mandrel 13 are coaxially arranged to transmit torque, axial load and rotary motion without loss. A measured rolling bearing mounting structure is arranged between the other end of the mandrel 13 and the sliding seat 10, wherein the measured rolling bearing mounting structure comprises a shaft shoulder 14 arranged at the end of the mandrel for mounting an inner ring 1 of the measured rolling bearing, and a bearing seat 15 for mounting an outer ring 2 of the measured rolling bearing is fixed on the sliding seat 10, wherein the bearing seat 15 is provided with an inner cylindrical surface 16 cooperating with an outer cylindrical surface of the outer ring 2 of the measured rolling bearing and an outer ring retaining shoulder 17, and the inner cylindrical surface (16) is coaxially arranged with the air-floating spindle 12, and the sliding seat 10 is driven by an external force to translate axially along the air-floating spindle 12; the moving parts on the rotary shafting includes the air-floating spindle 12, the mandrel 13, the inner ring 1 of the measured rolling bearing, the rolling element 3 of the measured rolling bearing and a cage of the measured rolling bearing (not shown in the figure); if the mandrel 13 is connected with the air-floating spindle 12 through the coupling, the rotary shafting further comprises the coupling, and the moving part on the rotary shafting also comprises the coupling; the rotational velocity sensor is used for monitoring the angular velocity of the mandrel 13 or the air-floating spindle 12; and the data acquisition/processing/calculation/display system is configured to acquire and process the angular velocity signal of the mandrel 13 or the air-floating spindle 12 monitored by the rotational velocity sensor, calculate the equivalent friction torque and equivalent friction coefficient of the measured rolling bearing, and display relevant information.

### Embodiment 2 of the Measurement Apparatus

The measurement apparatus of embodiment 2 is equally applicable to the measurement of the equivalent friction coefficient of the angular contact ball bearings, thrust ball bearings or single row tapered roller bearings, the measured rolling bearing mounting structure between the other end of the mandrel 13 and the sliding seat 10 is different from that of the embodiment 1 of the measurement apparatus described above.

FIG. 7 shows the structure of embodiment 2 of the measurement apparatus according to the present invention, the measurement apparatus comprises the machine body 9, the rotary shafting, the sliding seat 10, a rotational velocity sensor (not shown in the figure) and the data acquisition/processing/calculation/display system (not shown in the figure). The rotary shafting comprises the mandrel 13 and the support bearings supporting the mandrel 13 and is mounted between the machine body 9 and the sliding seat 10. One of the two support bearings for supporting the mandrel 13 is the air-floating spindle assembly, and the other is the measured rolling bearing. The air-floating spindle assembly includes the air-floating spindle base 11 and the air-floating spindle 12, and the air-floating spindle base 11 is fixed to the machine body 9. The connecting end of the mandrel 13 is connected with the air-floating spindle 12 through a conical surface (or connected with the air-floating spindle 12 through a coupling), to ensure that the air-floating spindle 12 and the mandrel 13 are coaxially arranged to transmit torque, axial load and rotary motion without loss. The measured rolling bearing mounting structure is arranged between the other end of the mandrel 13 and the sliding seat 10, wherein the measured rolling bearing mounting structure comprises a bearing seat arranged at the shaft shoulder 14 of the end of the mandrel 13 for mounting an outer ring 2 of the measured rolling bearing, and the bearing seat 15 is provided with an inner cylindrical surface 16 and an outer ring retaining shoulder 17 cooperating with the outer ring 2 of the measured rolling bearing, wherein a loading shaft 18 for mounting the inner ring 1 of the measured rolling bearing is fixed on the sliding seat 10, the loading shaft 18 is provided with an outer cylindrical surface 19 and an inner ring shoulder 20 cooperating with the inner cylindrical surface 16 of the inner ring 1 of the measured rolling bearing, and the outer cylindrical surface 19 is coaxially arranged with the air-floating spindle 12, and the sliding seat 10 is driven by an external force to translate axially along the air-floating spindle 12. The moving parts on the rotary shafting include the air-floating spindle 12, the mandrel 13, the bearing seat 15, the rolling element 3 of the measured rolling bearing and the cage (not shown in the figure) of the outer ring 2 of the measured rolling bearing; if the mandrel 13 is connected with the air-floating spindle 12 through the coupling, the rotary shafting further comprises the coupling, and the moving part on the rotary shafting also includes the coupling; the rotational velocity sensor is used for monitoring the angular velocity of the mandrel 13 or the air-floating spindle 12; the data acquisition/processing/calculation/display system is configured to acquire and process the angular velocity signal of the mandrel 13 or the air-floating spindle 12 monitored by the rotational velocity sensor, the equivalent friction torque and coefficient of friction of the rolling bearing are calculated and displayed.

In both embodiment 1 and embodiment 2 of the measurement apparatus, in which the rotary shafting is vertically arranged preferably, the axis of the air-floating spindle 12 is perpendicular to the horizontal plane.

In the case of measuring the equivalent friction coefficient by the measurement apparatus embodiment 1 or the measurement apparatus embodiment 2, the power device is provided on one side of the machine body 9, the output shaft of the power device is connected to or separated from the free end of the air-floating spindle 12 through a clutch device, and an axial loading device is arranged on one side of the sliding seat 10. The positions and connections of the power device, the clutch device and the axial loading device with the relevant parts of the measurement apparatus of the present invention are common knowledge in the art and are therefore not shown in the drawings.

The operation principle of the measurement apparatus embodiment 1 or the measurement apparatus embodiment 2 of the present disclosure is as follows: under the condition that applying a specified axial load to the outer ring 2 of the measured rolling bearing through the sliding seat 10 and the bearing seat 15 by the axial loading device of the measurement apparatus of embodiment 1 (shown as FIG. 6), or applying a specified axial load to the inner ring 2 of the measured rolling bearing through the sliding seat 10 and the loading shaft 18 by the axial loading device of the measurement apparatus of embodiment 2 (shown as FIG. 7), the power device drives the air-floating spindle 12 to rotate through the clutch device, after the air-floating spindle 12 and the mandrel 13 are increased to a given angular velocity of gyration, the clutch device separates the output shaft of the power device and the air-floating spindle 12. The rotation velocity of the mandrel 13 or the air-floating spindle 12 is gradually reduced by the friction power consumption of the measured rolling bearing until the mandrel 13 stops rotating; the data acquisition/processing/calculation/display system obtains the numerical relationship between the angular velocity of the mandrel and the time, calculates a motion speed and kinetic energy of all moving parts on the rotary shafting, obtains a numerical relationship between the total kinetic energy of the rotary shafting and time and takes a derivative of the numerical relationship between the total kinetic energy of the rotary shafting and time, wherein the derivative with respect to time is a decreasing rate of the total kinetic energy at a certain moment, which is also the friction power of the measured rolling bearing at the corresponding angular velocity at the moment, and is also equivalent to the friction power of the sliding friction pair of the corresponding virtual sliding bearing; the quotient of the friction power of the sliding friction pair divided by the angular velocity value is the friction torque of the slipping friction pair at the angular velocity, which is also equivalent to the equivalent friction torque of the measured rolling bearing at this angular speed; the quotient of the friction torque of the sliding friction pair at the angular velocity divided by the product of the radius R of the middle part of the sliding mating surface 8 of the virtual sliding bearing and the normal load at the sliding matching surface 8 is the friction coefficient of the friction pair at the angular velocity, which is also equivalent to the equivalent friction coefficient at the angular velocity of the measured rolling bearing; the normal load at the sliding matching surface 8 is equivalent to the normal component of the axial load of the corresponding measured rolling at the sliding mating surface 8, when the angular velocity of the air-floating spindle 12 and the mandrel 13 tends to zero, the corresponding equivalent friction torque and equivalent friction coefficient are equivalent to a starting equivalent friction torque and a starting equivalent friction coefficient of the measured rolling bearing.

### Embodiment 3 of the Measurement Apparatus

FIG. 8 shows the structure of a rolling bearing equivalent friction coefficient measuring apparatus of the disclosure according to embodiment 3 for the measurement of the equivalent friction coefficient of angular contact ball bearings or single row tapered roller bearings, wherein the measurement apparatus comprises the machine body 9, the rotary shafting, the sliding seat 10, the rotational velocity sensor (not shown in the figure) and the data acquisition/processing/calculation/display system (not shown in the figure). The rotary shafting comprises the mandrel 13 and support bearings supporting the mandrel 13 and is mounted between the machine body 9 and the sliding seat 10. The support bearings supporting the mandrel 13 are all the measured rolling bearings, which are respectively referred to as measured rolling bearing A 22 and measured rolling bearing B 23.

The two bearing seats 15, one of which is fixed to the machine body 9, the other one is fixedly connected with the sliding seat 10, and the two bearing seats 15 are respectively provided with an outer ring retaining shoulder 17 and an inner cylindrical surface 16 for mounting the measured rolling bearing A 22 and the measured rolling bearings B 23; the two ends of the mandrel 13 are respectively provided with shaft shoulders 14 for mounting the inner ring of the measured rolling bearing A 22 and the measured rolling bearing B 23, and the inner cylindrical surfaces 16 of the two bearing seats 15 are coaxially arranged; the sliding seat 10 can be axially translated along the inner cylindrical surfaces 16 of the two bearing seats 15 under the guidance of guiding members (not shown in the figure); the moving parts on the rotary shafting comprises the mandrel 13, the inner rings of the measured rolling bearing A 22 and the measured rolling bearings B 23, and the rolling elements of the measured rolling bearing A 22 and the measured rolling bearing B 23, a cage (not shown in the figure) of the measured rolling bearing A 22 and a cage of the measured rolling bearing B 23; the rotational velocity sensor is used to monitor the angular velocity of the mandrel 13, and the data acquisition/processing/calculation/display system is used for acquiring and processing the angular velocity signal of the mandrel 13 monitored by the rotational velocity sensor, the equivalent frictional torque and the equivalent friction coefficient of the measured rolling bearings A 22 and the measured rolling bearings B 23 are calculated, and the relevant information is displayed.

In the embodiment, the rotary shafting is vertically arranged, the axis of the inner cylindrical surface 16 of the two bearing seats 15 is perpendicular to the horizontal plane.

In the case of measuring the equivalent friction coefficient by the measurement apparatus embodiment 3, the power device is provided on one side of the machine body 9, the output shaft of the power device is connected to or separated from the mandrel 13 through a clutch device, and an axial loading device is arranged on one side of the sliding seat 10. The positions and connections of the power device, the clutch device and the axial loading device with the relevant parts of the measurement apparatus of the present invention are common knowledge in the art and are therefore not shown in the drawings.

In the measurement, two pairs of measured rolling bearings shall be measured twice; the two measured rolling bearings respectively bear two axial loads with opposite direction and different value due to the influence of the gravity G of the vertically arranged mandrel during measuring process; the equivalent friction torque and the equivalent friction coefficient of the two measured rolling bearings are analyzed according to the difference information caused by the position adjustment of the two measured rolling bearings in the two measuring processes.

The operation principle of the measurement apparatus embodiment 3 of the present disclosure is as follows: firstly, respectively mount the inner ring of the measured rolling bearing A 22 and the inner ring of the measured rolling bearing B 23 to shaft shoulders 14 on two ends of mandrel 13, and mount the outer ring of the measured rolling bearing A 22 to the outer ring retaining shoulder 17 fixedly connected to the machine body 9, and the outer ring of the measured rolling bearing B 23 to the outer ring retaining shoulder 17 of the bearing seat fixedly connected to the sliding seat 10; the axial loading device applies a specified axial load F₁ to the outer ring of the measured rolling bearing B 23 through the sliding seat 10 and the bearing seat 15 fixedly connected to the sliding seat 10, then the power device drives the mandrel 13 to rotate through the clutch device, and the clutch device separates the output shaft of the power device from the mandrel 13 after increasing the rotation velocity of the mandrel 13 to a given value, the rotational velocity sensor monitors the angular velocity of the mandrel 13 until the mandrel 13 stops rotating; the data acquisition/processing/calculation/display system acquires the numerical relationship ω(t) between the angular velocity of the mandrel and the time, and calculates the motion speed and kinetic energy of all moving parts on the rotary shafting, acquires the numerical relationship between the total kinetic energy of the rotary shafting and time, takes a derivative of the numerical relationship between the total kinetic energy of the rotary shafting and time, wherein the derivative with respect to time is a decreasing rate of the total kinetic energy at a certain moment t, which is also a sum of the friction powers of the measured rolling bearing A 22 and the measured rolling bearing B 23 at the corresponding angular velocity at the moment, thus obtains the numerical relationship P₁(ω) of the sum of the friction powers of the measured rolling bearing A 22 and the measured rolling bearing B 23 and the angular velocity.

Then, respectively mount the inner ring of the measured rolling bearing A 22 and the inner ring of the measured rolling bearing B 23 to shaft shoulders 14 on two ends of mandrel 13, and mount the outer ring of the measured rolling bearing A 22 to the outer ring retaining shoulder 17 fixedly connected to the sliding seat 10 and mount the outer ring of the measured rolling bearing B 23 to the outer ring retaining shoulder 17 of the bearing seat fixedly connected to the machine body 9; the axial loading device applies a specified axial load F₂ to the outer ring of the measured rolling bearing A 22 through the sliding seat 10 and the bearing seat 15 fixedly connected to the sliding seat 10, then the power device drives the mandrel 13 to rotate through the clutch device, and the clutch device separates the output shaft of the power device from the mandrel 13 after increasing the rotation velocity of the mandrel 13 to a given value, the rotational velocity sensor monitors the angular velocity of the mandrel 13 until the mandrel 13 stops rotating; the data acquisition/processing/calculation/display system acquires the numerical relationship ω(t) between the angular velocity of the mandrel and the time, and calculates the motion speed and kinetic energy of all moving parts on the rotary shafting, acquires the numerical relationship between the total kinetic energy of the rotary shafting and time, takes a derivative of the numerical relationship between the total kinetic energy of the rotary shafting and time, wherein the derivative with respect to time is a decreasing rate of the total kinetic energy at a certain moment t, which is also a sum of the friction powers of the measured rolling bearing A 22 and the measured rolling bearing B 23 at the corresponding angular velocity at the moment, thus obtains the numerical relationship P₂(ω) of the sum of the friction powers of the measured rolling bearing A 22 and the measured rolling bearing B 23 and the angular velocity. The friction power of the measured rolling bearing at the corresponding angular velocity at a certain angular velocity is equivalent to the friction power of the sliding friction pair of the corresponding virtual sliding bearing; the quotient of the friction power of the sliding friction pair divided by the angular velocity value is the friction torque of the slipping friction pair at the angular velocity, which is also equivalent to the equivalent friction torque of the measured rolling bearing at this angular speed; the quotient of the friction torque of the sliding friction pair at the angular velocity divided by the product of the radius R of the middle part of the sliding mating surface 8 of the virtual sliding bearing and the normal load at the sliding matching surface 8 is the friction coefficient of the friction pair at the angular velocity, which is also equivalent to the equivalent friction coefficient at the angular velocity of the measured rolling bearing; the normal load at the sliding matching surface 8 is equivalent to the normal component of the axial load of the corresponding measured rolling at the sliding mating surface 8, which is a quotient of an axial load on the measured rolling bearing divided by the sine of a contact angle α of the measured rolling bearing.

At last, for different angular velocities ω₁, ω₂, ω₃ [symbol] . . . . , establish a binary linear equations in accordance with the constitution of the sum of the friction power of the measured rolling bearing A 22 and the measured rolling bearing B 23 under two measuring conditions in a range of a measured angular velocity:

$$\{ \begin{matrix}\frac{{F}_{1} + G}{sin α} {μ}_{A} ( ω ) R ω + \frac{{F}_{1}}{sin α} {μ}_{B} ( ω ) R ω = {P}_{1} ( ω ) \\ \frac{{F}_{2}}{sin α} {μ}_{A} ( ω ) R ω + \frac{{F}_{2} + G}{sin α} {μ}_{B} ( ω ) R ω = {P}_{2} ( ω )\end{matrix} , ω = {ω}_{1 } {ω}_{2} {ω}_{3} …$$

wherein, the first term on a left side of the equal sign of the equations is the friction power of the measured rolling bearing A, the second term is the frictional power of the measured rolling bearing B, and G is the gravity of the mandrel 13, μ_{A}(ω) [symbol] μ_{B}(ω) is the numerical relationship between the equivalent friction coefficient and the angular velocity of measured rolling bearing A 22 and the measured rolling bearing B 23 respectively.

Obtain the numerical relationship between the equivalent friction coefficient and the angular velocity μ_{A}(ω), μ_{B}(ω) of measured rolling bearing A and measured rolling bearing B respectively by solving the binary linear equations above;

When F₁=F₂=F, the numerical relationship between the equivalent friction coefficient and the angular velocity of the measured rolling bearing A and measured rolling bearing B are respectively as follows:

$$\{ \begin{matrix}{μ}_{A} ( ω ) = \frac{( F + G ) {P}_{2} ( ω ) sin α - F {P}_{1} ( ω ) sin α}{( 2 F + G ) G R ω} \\ {μ}_{B} ( ω ) = \frac{( F + G ) {P}_{1} ( ω ) sin α - F {P}_{2} ( ω ) sin α}{( 2 F + G ) G R ω} \end{matrix} , ω = {ω}_{1 } {ω}_{2} {ω}_{3 } …$$

In accordance with the mechanical relationship between the friction torque and the friction coefficient, when the axial load on the measured rolling bearing A and the measured rolling bearing B are F, numerical relationship M_{A}(ω), M_{B}(ω) between the equivalent friction torque and the angular velocity of the measured rolling bearing A 22 and the measured rolling bearing B 23 are respectively as follows:

$$\{ \begin{matrix}{M}_{A} ( ω ) = \frac{{μ}_{A} ( ω ) F R}{sin α} \\ {M}_{B} ( ω ) = \frac{{μ}_{B} ( ω ) F R}{sin α} \end{matrix} , ω = {ω}_{1 } {ω}_{2} {ω}_{3} …$$

when the angular velocity of the mandrel 13 tends zero, the corresponding equivalent friction torque and equivalent friction coefficient are respectively equivalent to the starting equivalent friction torque and starting equivalent frictional coefficient of the measured rolling bearing A 22 and the measured rolling bearing B 23.

### Embodiment 4 of the Measurement Apparatus

FIG. 9 shows the structure of a rolling bearing equivalent friction coefficient measuring apparatus of the disclosure according to embodiment 4 for the measurement of the equivalent friction coefficient of deep groove ball bearings and cylindrical roller bearings, wherein the measurement apparatus comprises the machine body 9, the rotary shafting, the sliding seat 10, the rotational velocity sensor (not shown in the figure) and the data acquisition/processing/calculation/display system (not shown in the figure). The rotary shafting comprises the mandrel 13 and support bearings supporting the mandrel 13 and is mounted between the machine body 9 and the sliding seat 10. The support bearings supporting the mandrel 13 are all air-floating spindle assemblies.

The air-floating spindle assemblies comprise the air-floating spindle base 11 and the air-floating spindle 12, wherein one of the air-floating spindle bases 11 is fixedly connected with the machine body 9, while the other one is fixedly connected with the sliding seat 10, and the two air-floating spindles 12 are coaxially arranged; both ends of the mandrel 13 are respectively connected with the two air-floating spindles 12 through the conical surface or the coupling, and the mandrel 13 is coaxially arranged with the two air-floating spindles 12; the mandrel 13 is provided with a shaft shoulder 14 for mounting an inner ring 1 of the measured rolling bearing, and the sliding seat 10 is driven by an external force to translate axially along the air-floating spindle 12; the rotary shafting comprises the two air-floating spindles 12, the mandrel 13, the inner ring 1 of the measured rolling bearing, a rolling element 3 and a cage of the measured rolling bearing (not shown in the figure); if the mandrel 13 is connected with the two air-floating spindles 12 through the coupling, the rotary shafting further comprises the coupling, and the moving part on the rotary shafting also comprises the coupling; the rotational velocity sensor is used to monitor the angular velocity of the mandrel 13 or the air-floating spindle 12, and the data acquisition/processing/calculation/display system is used for acquiring and processing the angular velocity signal of the mandrel 13 or the air-floating spindle 12 monitored by the rotational velocity sensor, the equivalent frictional torque and the equivalent friction coefficient of the measured rolling bearings are calculated and displayed.

In the embodiment, the rotary shafting is horizontally arranged, and the axes of the air-floating spindle 12 is parallel to the horizontal plane.

In the case of measuring the equivalent friction coefficient by the measurement apparatus embodiment 4, the power device is provided, the output shaft of the power device is connected to or separated from the free end of one of the air-floating spindle 12 through the clutch device, a radial loading device is arranged radially along the measured rolling bearing, the positions and connections of the power device, the clutch device and the radial loading device with the relevant parts of the measurement apparatus of the present invention are common knowledge in the art and are therefore not shown in the drawings.

The operation principle of the measurement apparatus embodiment 4 of the present disclosure is as follows: the radial loading device applies a specified radial load to the outer ring 2 of the measured rolling bearing, the power device drives one of the air-bearing spindles 12 to rotate through the clutch device, after the air-floating spindle 12 and the mandrel 13 are rotated to a given angular velocity of gyration, the clutch device separates the output shaft of the power device and the air-floating spindle 12, and the rotational velocity sensor monitors the angular velocity of the mandrel 13 or the air-floating spindle 12 until the air-floating spindle 12 and the mandrel 13 stop rotating; the data acquisition/processing/calculation/display system acquires the numerical relationship between the angular velocity of the mandrel and the time, and calculates the motion speed and kinetic energy of all moving parts on the rotary shafting, acquires the numerical relationship between the total kinetic energy of the rotary shafting and time, takes a derivative of the numerical relationship between the total kinetic energy of the rotary shafting and time, wherein the derivative with respect to time is a decreasing rate of the total kinetic energy at a certain moment, which is also the friction powers of the measured rolling bearing at the corresponding angular velocity at the moment and is also the friction power of the sliding friction pair of the corresponding virtual journal sliding bearing; the quotient of the friction power of the sliding friction pair divided by the angular velocity is the equivalent friction torque of the sliding friction pair at the angular velocity, which is also the equivalent friction torque of the measured rolling bearing at the angular velocity; the quotient of the friction torque of the sliding friction pair at the angular velocity divided by the product of the radius R of the sliding mating surface 8 of the virtual journal sliding bearing and the radial load at the sliding matching surface 8 is the friction coefficient of the friction pair at the angular velocity, which is also the equivalent friction coefficient of the measured rolling bearing at the angular velocity; when the angular velocity of the mandrel 13 and the air-floating spindle 12 tend to zero, the corresponding equivalent friction torque and equivalent friction coefficient are equivalent to a starting equivalent friction torque and a starting equivalent friction coefficient of the measured rolling bearing.

### Embodiment 5 of the Measurement Apparatus

FIG. 10 shows the structure of a rolling bearing equivalent friction coefficient measuring apparatus of the disclosure according to embodiment 5 for the measurement of the equivalent friction coefficient of deep groove ball bearings and cylindrical roller bearings, wherein the measurement apparatus comprises the machine body 9, the rotary shafting, the sliding seat 10, the rotational velocity sensor (not shown in the figure) and the data acquisition/processing/calculation/display system (not shown in the figure). The rotary shafting comprises a ring-shaped counterweight of the mandrel 13 and support bearings supporting the mandrel 13 and is mounted between the machine body 9 and the sliding seat 10. The support bearings supporting the mandrel 13 are all measured rolling beading and are referred as the measured rolling beading A 22 and the measured rolling beading B 23 respectively.

The two bearing seats 15, one of which is fixed to the machine body 9, the other one is fixedly connected with the sliding seat 10, and the two bearing seats 15 are respectively provided with an inner cylindrical surface 16 cooperating with an outer cylindrical surface of the outer ring of the measured rolling bearing A 22 and the measured rolling bearings B 23; the inner cylindrical surfaces 16 of the two bearing seats 15 are coaxially arranged; two ends of the mandrel 13 are respectively provided with a shaft shoulder 14 for mounting the inner ring of the measured rolling bearing A 22 and the measured rolling bearings B 23; the mandrel 13 is provided with a ring-shaped counterweight 21; the sliding seat 10 is driven by an external force to translate axially along the inner cylindrical surface 16 of the bearing seats under the guidance of the guide member (not shown in the figure); the rotary shafting comprises the mandrel 13, the inner ring of the measured rolling bearing A 22, the inner ring of the measured rolling bearing B 23, the rolling element of the measured rolling bearing A 22, the rolling element of the measured rolling bearing B 23, a cage (not shown in the figure) of the measured rolling bearing A 22, a cage (not shown in the figure) of the measured rolling bearing B 23 and the ring-shaped counterweight 21; the rotational velocity sensor is used to monitor the angular velocity of the mandrel 13, and the data acquisition/processing/calculation/display system is used for acquiring and processing the angular velocity signal of the mandrel 13 monitored by the rotational velocity sensor, the equivalent frictional torque and the equivalent friction coefficient of the measured rolling bearings A 22 and the measured rolling bearings B 23 are calculated and displayed.

The two bearing seats 15 are arranged horizontally, and the axes of the inner cylindrical surfaces 16 of the two seats are parallel to a horizontal plane.

In the case of measuring the equivalent friction coefficient by the measurement apparatus embodiment 5, the power device is provided, wherein the output shaft of the power device is connected to or separated from a free end of the mandrel 13 through a clutch device, and a radial loading device is arranged radially along the measured rolling bearing. The positions and connections of the power device, the clutch device and the axial loading device with the relevant parts of the measurement apparatus of the present invention are common knowledge in the art and are therefore not shown in the drawings.

In the measurement of the equivalent friction coefficient by the measurement apparatus of embodiment 5, two pairs of measurements are needed on the two measured rolling bearings; adjust the mass of the ring-shaped counterweight 21 and its axial position on the mandrel 13 such that the combination of the radial support reaction of the measured rolling bearing A 22 and the measured rolling bearing B 23 is linearly independent during the two measurements; according to the difference information produced by the two measured rolling bearings of two groups of linearly independent radial support reaction in the two measuring processes, the equivalent friction torque and equivalent friction coefficient of the two measured rolling bearings are analyzed.

The operation principle of the measurement apparatus embodiment 5 of the present disclosure is as follows: firstly, respectively mount the inner ring of the measured rolling bearing A 22 and the inner ring of the measured rolling bearing B 23 to shaft shoulders 14 on two ends of mandrel; mount the outer ring of the measured rolling bearing A 22 and the measured rolling bearing B 23 to the inner cylindrical surface 16 of the two bearing seats 15; adjusting the mass of the ring-shaped counterweight 21 and its axial position on the mandrel 13 such that the radial support reaction of the measured rolling bearing A 22 and the measured rolling bearing B 23 are F_{1A} and F_{1B} respectively; then the power device drives the mandrel 13 to rotate through the clutch device, and the clutch device separates the output shaft of the power device from the mandrel 13 after increasing the rotation velocity of the mandrel 13 to a given value, the rotational velocity sensor monitors the angular velocity of the mandrel 13 until the mandrel 13 stops rotating; the data acquisition/processing/calculation/display system acquires the numerical relationship ω(t) between the angular velocity of the mandrel and the time, and calculates the motion speed and kinetic energy of all moving parts on the rotary shafting, acquires the numerical relationship between the total kinetic energy of the rotary shafting and time, takes a derivative of the numerical relationship between the total kinetic energy of the rotary shafting and time, wherein the derivative with respect to time is a decreasing rate of the total kinetic energy at a certain moment t, which is also a sum of the friction powers of the measured rolling bearing A 22 and the measured rolling bearing B 23 at the corresponding angular velocity at the moment, thus obtains the numerical relationship P₁(ω) of the sum of the friction powers of the measured rolling bearing A 22 and the measured rolling bearing B 23 and the angular velocity.

Then adjust the mass of the ring-shaped counterweight and the axial position on the mandrel 13 such that the radial support reaction of the measured rolling bearing A 22 and the measured rolling bearing 23 B are F_{2A} and F_{2B} respectively, wherein the F_{2A}, F_{2B} and F_{1A}, F_{1B} are linearly independent; the power device drives the mandrel 13 to rotate through the clutch device, and the clutch device separates the output shaft of the power device from the mandrel 13 after increasing the rotation velocity of the mandrel 13 to a given value, the rotational velocity sensor monitors the angular velocity of the mandrel 13 until the mandrel 13 stops rotating; the data acquisition/processing/calculation/display system acquires the numerical relationship ω(t) between the angular velocity of the mandrel and the time, and calculates the motion speed and kinetic energy of all moving parts on the rotary shafting, acquires the numerical relationship between the total kinetic energy of the rotary shafting and time, takes a derivative of the numerical relationship between the total kinetic energy of the rotary shafting and time, wherein the derivative with respect to time is a decreasing rate of the total kinetic energy at a certain moment t, which is also a sum of the friction powers of the measured rolling bearing A 22 and the measured rolling bearing B 23 at the corresponding angular velocity at the moment, thus obtains the numerical relationship P₂(ω) of the sum of the friction powers of the measured rolling bearing A 22 and the measured rolling bearing B 23 and the angular velocity.

The friction power of the measured rolling bearing at the corresponding angular velocity at a certain angular velocity is equivalent to the friction power of the sliding friction pair of the corresponding virtual journal sliding bearing; the quotient of the friction power of the sliding friction pair divided by the angular velocity value of the measured rolling bearing is the friction torque of the slipping friction pair at the angular velocity, which is also equivalent to the equivalent friction torque of the measured rolling bearing at the angular velocity; the quotient of the friction torque of the sliding friction pair at the angular velocity divided by the product of the radius R of the sliding mating surface 8 of the virtual journal sliding bearing and the radial load at the sliding matching surface 8 is the friction coefficient of the friction pair at the angular velocity, which is also equivalent to the equivalent friction coefficient at the angular velocity of the measured rolling bearing; the radial load at the sliding matching surface 8 is equivalent to the radial support reaction of the corresponding measured rolling bearing.

At last, for different angular velocities ω₁, ω₂, ω₃ [symbol] . . . , establish a binary linear equations in accordance with the constitution of the sum of the friction power of the measured rolling bearing A 22 and the measured rolling bearing B 23 under two measuring conditions in a range of a measured angular velocity:

$$\{ \begin{matrix}{F}_{1 A} {μ}_{A} ( ω ) R ω + {F}_{1 B} {μ}_{B} ( ω ) R ω = {P}_{1} ( ω ) \\ {F}_{2 A} {μ}_{A} ( ω ) R ω + {F}_{2 B} {μ}_{B} ( ω ) R ω = {P}_{2} ( ω )\end{matrix} , ω = {ω}_{1 } {ω}_{2} {ω}_{3} …$$

wherein, the first term on a left side of the equal sign of the equations is the friction power of the measured rolling bearing A, the second term is the frictional power of the measured rolling bearing B, μ_{A}(ω) [symbol] μ_{B}(ω) is the numerical relationship between the equivalent friction coefficient and the angular velocity of measured rolling bearing A 22 and measured rolling bearing B 23 respectively.

Obtain the numerical relationship between the equivalent friction coefficient and the angular velocity μ_{A}(ω), μ_{B}(ω) of measured rolling bearing A and measured rolling bearing B respectively by solving the binary linear equations above;

$$\{ \begin{matrix}{μ}_{A} ( ω ) = \frac{{F}_{2 B} {P}_{1} ( ω ) - {F}_{1 B} {P}_{2} ( ω )}{( {F}_{1 A} {F}_{2 B} - {F}_{1 B} {F}_{2 A} ) R ω} \\ {μ}_{B} ( ω ) = \frac{{F}_{1 A} {P}_{2} ( ω ) - {F}_{2 A} {P}_{1} ( ω )}{( {F}_{1 A} {F}_{2 B} - {F}_{1 B} {F}_{2 A} ) R ω} \end{matrix} , ω = {ω}_{1 } {ω}_{2} {ω}_{3} …$$

In accordance with the mechanical relationship between the friction torque and the friction coefficient, when the radial load on the measured rolling bearing A and the measured rolling bearing B are F, numerical relationship M_{A}(ω), M_{B}(ω) between the equivalent friction torque and the angular velocity of the measured rolling bearing A 22 and the measured rolling bearing B 23 are respectively as follows:

$$\{ \begin{matrix}{M}_{A} ( ω ) = {μ}_{A} ( ω ) F R \\ {M}_{B} ( ω ) = {μ}_{B} ( ω ) F R\end{matrix} , ω = {ω}_{1 } {ω}_{2} {ω}_{3 } …$$

when the angular velocity of the mandrel 13 tends zero, the corresponding equivalent friction torque and equivalent friction coefficient are respectively equivalent to the starting equivalent friction torque and starting equivalent frictional coefficient of the measured rolling bearing A 22 and the measured rolling bearing B 23.

### Embodiment 1 of the Measurement Method

The measurement method corresponding to embodiment 1 of the measurement apparatus in the present disclosure comprises:

Step 1, connecting one end of the mandrel 13 with the air-floating spindle 12 through the conical surface or the coupling, and mounting the inner ring 1 of the measured rolling bearing to the shaft shoulder 14 on the other end of the mandrel 13, moving the sliding seat 10 to mount the outer ring 2 of the measured rolling bearing to the outer ring retaining shoulder 17 of the bearing seat;

Step 2, applying a specified axial load to the outer ring 2 of the measured rolling bearing through the sliding seat 10 and the bearing seat (15) by the axial loading device according to the type and size of the measured rolling bearing, and the specifications for measuring the friction torque of rolling bearing, such as the National Standard of the People's Republic of China GB/T32562-2016 “Measuring Method for Friction Torque of Rolling Bearing”;

Step 3, driving the air-floating spindle 12 to rotate by the power device through the clutch device, keeping the air-floating spindle 12, the mandrel 13, the inner ring 1 of the measured rolling bearing rotating synchronously; acquiring and processing an angular velocity signal from the rotational velocity sensor of the mandrel 13, and calculating and displaying the angular velocity of the mandrel 13 by the data acquisition/processing/calculation/display system;

Step 4, increasing the rotation velocity of the air-floating spindle 12 and the mandrel 13 to a given value gradually, separating the output shaft of the power device from the air-floating spindle 12 by the clutch device after the rotation velocity is stabilized; gradually attenuating the rotation velocity of the mandrel 13 under the friction power consumption of the measured rolling bearing until the mandrel 13 and air-floating spindle 12 stop rotating; obtaining the numerical relationship between the angular velocity of the mandrel 13 and time by the data acquisition/processing/calculation/display system;

Step 5, calculating a motion speed and kinetic energy of all moving parts on the rotary shafting by the data acquisition/processing/calculation/display system; obtaining a numerical relationship between the total kinetic energy of the rotary shafting and time; taking a derivative of the numerical relationship between the total kinetic energy of the rotary shafting and time, wherein the derivative with respect to time is a decreasing rate of the total kinetic energy at a certain moment, which is also the friction power of the measured rolling bearing at the corresponding angular velocity at the moment, and the quotient of the friction power of the measured rolling bearing divided by the angular velocity is the equivalent friction torque of the measured rolling bearing at the angular velocity; the quotient of the equivalent friction torque of the measured rolling bearing divided by the product of the radius R at the middle portion of the sliding mating surface of the virtual sliding bearing corresponding to the measured rolling bearing and the normal load at the sliding matching surface 8 is the equivalent friction coefficient of the measured rolling bearing at the angular velocity; the normal load at the sliding matching surface 8 is equivalent to the normal component of the axial load of the corresponding measured rolling at the sliding mating surface 8; when the angular velocity of the mandrel 13 and the air-floating spindle 12 tend to zero, the corresponding equivalent friction torque and equivalent friction coefficient are equivalent to a starting equivalent friction torque and a starting equivalent friction coefficient of the measured rolling bearing.

### Embodiment 2 of the Measurement Method

Compared with embodiment 1, the measurement method provided in embodiment 2 of the measurement apparatus is different from the measurement method provided in embodiment 1 in that:

Step 1, connecting one end of the mandrel 13 with the air-floating spindle 12 through the conical surface or the coupling, and mounting the bearing seat 15 to the shaft shoulder 14 of the other end of the mandrel, moving the sliding seat 10 to mount the inner ring 1 of the measured rolling bearing to an inner ring shoulder 20 of the loading shaft, mounting the outer ring 2 of the measured rolling bearing to the outer ring retaining shoulder 17 of the bearing seat;

Step 2, applying a specified axial load to the inner ring 1 of the measured rolling bearing through the sliding seat 10 and the loading shaft 18 by the axial loading device according to the type and size of the measured rolling bearing, and the specifications for measuring the friction torque of rolling bearing, such as the National Standard of the People's Republic of China GB/T32562-2016 “Measuring Method for Friction Torque of Rolling Bearing”;

Step 3, driving the air-floating spindle 12 to rotate by the power device through the clutch device, keeping the air-floating spindle 12, the mandrel 13, and the outer ring 2 of the measured rolling bearing rotating synchronously; acquiring and processing an angular velocity signal from the rotational velocity sensor of the mandrel 13 or the air-floating spindle 12, and calculating and displaying the angular velocity of the mandrel 13 by the data acquisition/processing/calculation/display system;

Step 4 and step 5 are the same as the measurement method in embodiment 1.

### Embodiment 3 of the Measurement Method

The measurement method corresponding to embodiment 3 of the measurement apparatus in the present disclosure comprises:

Step 1, respectively mounting the inner ring of the measured rolling bearing A 22 and the inner ring of the measured rolling bearing B 23 to shaft shoulders 14 on two ends of mandrel; moving the sliding seat to mount the outer ring of the measured rolling bearing A 22 to an outer ring retaining shoulder 17 fixedly connected to the machine body 9, and the outer ring of the measured rolling bearing B 23 to the outer ring retaining shoulder 17 of the bearing seat fixedly connected to the sliding seat 10;

Step 2, applying a specified axial load F₁ to the outer ring of the measured rolling bearing B 23 through the sliding seat 10 and the bearing seat 15 fixedly connected to the sliding seat 10 by the axial loading device according to the type and size of the measured rolling bearing, and the specifications for measuring the friction torque of rolling bearing, such as the National Standard of the People's Republic of China GB/T32562-2016 “Measuring Method for Friction Torque of Rolling Bearing”;

Step 3, driving the mandrel 13 to rotate by the power device through the clutch device, keeping the mandrel 13, the inner ring of the measured rolling bearing A 22 and the inner ring of the measured rolling bearing B 23 rotating synchronously; acquiring and processing an angular velocity signal from the rotational velocity sensor of the mandrel 13, and calculating and displaying the angular velocity of the mandrel 13 by the data acquisition/processing/calculation/display system;

Step 4, increasing the rotation velocity of the mandrel 13 to a given value gradually; separating the output shaft of the power device from the mandrel 13 by the clutch device after the rotation velocity is stabilized; gradually attenuating the rotation velocity of the mandrel 13 under the action of the friction power consumption of the measured rolling bearing A 22 and the measured rolling bearing B 23 until the mandrel stops rotating; obtaining the numerical relationship ω(t) between the angular velocity of the mandrel and time by the data acquisition/processing/calculation/display system;

Step 5, calculating a motion speed and kinetic energy of all moving parts on the rotary shafting by the data acquisition/processing/calculation/display system; obtaining a numerical relationship between the total kinetic energy of the rotary shafting and time; taking a derivative of the numerical relationship between the total kinetic energy of the rotary shafting and time, wherein the derivative with respect to time is a decreasing rate of the total kinetic energy at a certain moment t, which is also a sum of the friction powers of the measured rolling bearing A 22 and the measured rolling bearing B 23 at the corresponding angular velocity at the moment, thus obtaining a numerical relationship P₁(ω) of the sum of the friction powers of the measured rolling bearing A and the measured rolling bearing B and the angular velocity;

Step 6, respectively mounting the inner ring of the measured rolling bearing A 22 and the inner ring of the measured rolling bearing B 23 to shaft shoulders 14 on two ends of the mandrel 13; moving the sliding seat 10 to mount the outer ring of the measured rolling bearing B 23 to the outer ring retaining shoulder 17 fixedly connected to the machine body 9, and the outer ring of the measured rolling bearing A 22 to the outer ring retaining shoulder 17 of the bearing seat fixedly connected to the sliding seat 10;

Step 7, applying a specified axial load F₂ to the outer ring of the measured rolling bearing A 22 through the sliding seat 10 and the bearing seat 15 fixedly connected to the sliding seat 10 by the axial loading device according to the type and size of the measured rolling bearing, and the specifications for measuring the friction torque of rolling bearing, such as the National Standard of the People's Republic of China GB/T32562-2016 “Measuring Method for Friction Torque of Rolling Bearing”;

Step 8, repeating the step 3, step 4, step 5, and obtaining the numerical relationship ω(t) between the angular velocity of the mandrel and the time, the numerical relationship between the total kinetic energy of the rotary shafting and time, and obtaining a numerical relationship P₂(ω) of the sum of the friction powers of the measured rolling bearing A and the measured rolling bearing B and the angular velocity by the data acquisition/processing/calculation/display system;

Step 9, the quotient of the friction power of the measured rolling bearing divided by a angular velocity of gyration of the measured rolling bearing is the equivalent friction torque of the measured rolling bearing at the angular velocity; the quotient of the equivalent friction torque of the measured rolling bearing divided by the product of the radius R at the middle portion of the sliding mating surface of the virtual sliding bearing corresponding to the measured rolling bearing and the normal load at the sliding matching surface 8 is the equivalent friction coefficient of the measured rolling bearing at the angular velocity; the normal load at the sliding matching surface 8 is equivalent to the normal component of an axial load of the corresponding measured rolling bearing at the sliding mating surface, which is a quotient of an axial load on the measured rolling bearing divided by the sine of a contact angle α of the measured rolling bearing; for different angular velocities ω₁, ω₂, ω₃ [symbol] . . . . , establishing a binary linear equations in accordance with the constitution of the sum of the friction power of the measured rolling bearing A 22 and the measured rolling bearing B 23 under two measuring conditions in a range of a measured angular velocity:

$$\{ \begin{matrix}\frac{{F}_{1} + G}{sin α} {μ}_{A} ( ω ) R ω + \frac{{F}_{1}}{sin α} {μ}_{B} ( ω ) R ω = {P}_{1} ( ω ) \\ \frac{{F}_{2}}{sin α} {μ}_{A} ( ω ) R ω + \frac{{F}_{2} + G}{sin α} {μ}_{B} ( ω ) R ω = {P}_{2} ( ω )\end{matrix} , ω = {ω}_{1 } {ω}_{2} {ω}_{3} …$$

wherein, a first term on a left side of the equal sign of the equations is the friction power of the measured rolling bearing A 22, a second term is the frictional power of the measured rolling bearing B 23, and G is the gravity of the mandrel 13, μ_{A}(ω) [symbol] μ_{B}(ω) is the numerical relationship between the equivalent friction coefficient and the angular velocity of measured rolling bearing A and measured rolling bearing B respectively; obtaining the numerical relationship between the equivalent friction coefficient and the angular velocity μ_{A}(ω), μ_{B}(ω) of measured rolling bearing A and measured rolling bearing B respectively by solving the binary linear equations above; in accordance with the mechanical relationship between the friction torque and the friction coefficient, when the axial load on the measured rolling bearing A 22 and the measured rolling bearing B 23 are F, numerical relationship M_{A}(ω), M_{B}(ω) between the equivalent friction torque and the angular velocity of the measured rolling bearing A and the measured rolling bearing B are respectively as follows:

$$\{ \begin{matrix}{M}_{A} ( ω ) = \frac{{μ}_{A} ( ω ) F R}{sin α} \\ {M}_{B} ( ω ) = \frac{{μ}_{B} ( ω ) F R}{sin α} \end{matrix} , ω = {ω}_{1 } {ω}_{2} {ω}_{3 } …$$

when the angular velocity of the mandrel 13 tends zero, the corresponding equivalent friction torque and equivalent friction coefficient are respectively equivalent to the starting equivalent friction torque and starting equivalent frictional coefficient of the measured rolling bearing A 22 and the measured rolling bearing B 23.

### Embodiment 4 of the Measurement Method

The measurement method corresponding to embodiment 4 of the measurement apparatus in the present disclosure comprises:

Step 1, mounting the inner ring of the measured rolling bearing on the shaft shoulder 14 of the mandrel 13; connecting the both ends of the mandrel 13 to the two air-floating spindles 12 respectively through the conical surface or the coupling;

Step 2, applying a specified radial load to the outer ring 2 of the measured rolling bearing through the radial loading device according to the type and size of the measured rolling bearing, and the specifications for measuring the friction torque of rolling bearing, such as the National Standard of the People's Republic of China GB/T32562-2016 “Measuring Method for Friction Torque of Rolling Bearing”;

Step 3, driving the mandrel to rotate by the power device through the clutch device; keeping the air-floating spindle 12, the mandrel 13 and the inner ring 1 of the measured rolling bearing rotating synchronously; acquiring and processing an angular velocity signal from the rotational velocity sensor of the mandrel 13, and calculating and displaying the angular velocity of the mandrel by the data acquisition/processing/calculation/display system;

Step 4, increasing the rotation velocity of the air-floating spindle 12 and the mandrel 13 to a given value gradually; separating the output shaft of the power device from the air-floating by the clutch device after the rotation velocity is stabilized; gradually attenuating the rotation velocity of the mandrel 13 under the action of the friction power consumption of the measured rolling bearing until the mandrel 13 stops rotating; obtaining the numerical relationship between the angular velocity of the mandrel and the time by the data acquisition/processing/calculation/display system;

Step 5, calculating a motion speed and kinetic energy of all moving parts on the rotary shafting by the data acquisition/processing/calculation/display system; obtaining a numerical relationship between the total kinetic energy of the rotary shafting and time; taking a derivative of the numerical relationship between the total kinetic energy of the rotary shafting and time, wherein the derivative with respect to time is a decreasing rate of the total kinetic energy at a certain moment, which is also the friction power of the measured rolling bearing at the corresponding angular velocity at the moment, and the quotient of the friction power of the measured rolling bearing divided by the angular velocity is the equivalent friction torque of the measured rolling bearing at the angular velocity; the quotient of the equivalent friction torque of the measured rolling bearing divided by the product of the radius R at the sliding mating surface 8 of a virtual journal sliding bearing corresponding to the measured rolling bearing and the radial load at the sliding matching surface 8 is the equivalent friction coefficient of the measured rolling bearing at the angular velocity; when the angular velocity of the air-floating spindle 12 and the mandrel 13 tend to zero, the corresponding equivalent friction torque and equivalent friction coefficient are equivalent to a starting equivalent friction torque and a starting equivalent friction coefficient of the measured rolling bearing.

### Embodiment 5 of the Measurement Method

The measurement method corresponding to embodiment 5 of the measurement apparatus in the present disclosure comprises:

Step 1, respectively mounting the inner ring of the measured rolling bearing A 22 and the inner ring of the measured rolling bearing B 23 to shaft shoulders 14 on two ends of mandrel 13; moving the sliding seat 10 to mount the outer ring of the measured rolling bearing A 22 and the measured rolling bearing B 23 to the inner cylindrical surface 16 of the two bearing seats 15;

Step 2, adjusting a mass and an axial position on the mandrel 13 of the ring-shaped counterweight 21 according to the type and size of the measured rolling bearing, wherein the radial support reaction of the measured rolling bearing A 22 and the measured rolling bearing B 23 are F_{1A} and F_{1B} respectively according to the specifications for measuring the friction torque of rolling bearing, such as the National Standard of the People's Republic of China GB/T32562-2016 “Measuring Method for Friction Torque of Rolling Bearing”;

Step 3, driving the mandrel 13 to rotate by the power device through the clutch device, keeping the mandrel 13, the inner ring of the measured rolling bearing A 22, the inner ring of the measured rolling bearing B 23 and the ring-shaped counterweight 21 rotating synchronously; acquiring and processing an angular velocity signal from the rotational velocity sensor of the mandrel 13, and calculating and displaying the angular velocity of the mandrel by the data acquisition/processing/calculation/display system;

Step 4, increasing the rotation velocity of the mandrel 13 to a given value gradually; separating the output shaft of the power device from the mandrel 13 by the clutch device after the rotation velocity is stabilized; gradually attenuating the rotation velocity of the mandrel 13 under the action of the friction power consumption of the measured rolling bearing A 22 and the measured rolling bearing B 23 until the mandrel stops rotating; obtaining the numerical relationship ω(t) between the angular velocity of the mandrel and time by the data acquisition/processing/calculation/display system;

Step 5, calculating a motion speed and kinetic energy of all moving parts on the rotary shafting by the data acquisition/processing/calculation/display system; obtaining a numerical relationship between the total kinetic energy of the rotary shafting and time; taking a derivative of the numerical relationship between the total kinetic energy of the rotary shafting and time, wherein the derivative with respect to time is a decreasing rate of the total kinetic energy at a certain moment, which is also the friction powers of the measured rolling bearing at the corresponding angular velocity at the moment, thus obtaining a numerical relationship P₁(ω) of the sum of the friction powers of the measured rolling bearing A and the measured rolling bearing B and the angular velocity;

Step 6, adjusting the mass and the axial position on the mandrel 13 of the ring-shaped counterweight 21 according to the type and size of the measured rolling bearing, wherein the radial support reaction of the measured rolling bearing A 22 and the measured rolling bearing B 23 are F_{2A} and F_{2B} respectively and meet the requirements of the friction torque measurement specification of the rolling bearing for applying radial load, wherein the F_{2A}, F_{2B} and F_{1A}, F_{1B} are linearly independent;

Step 7, repeating the step 3, step 4, step 5, and obtaining the numerical relationship ω(t) between the angular velocity of the mandrel and the time in real time, the numerical relationship between the total kinetic energy of the rotary shafting and time, and obtaining a numerical relationship P₂(ω) of the sum of the friction powers of the measured rolling bearing A and the measured rolling bearing B and the angular velocity by the data acquisition/processing/calculation/display system;

Step 8, the quotient of the friction power of the measured rolling bearing divided by a angular velocity of gyration of the measured rolling bearing is the equivalent friction torque of the measured rolling bearing at the angular velocity; the quotient of the equivalent friction torque of the measured rolling bearing divided by the product of the radius R of the sliding mating surface of the virtual journal sliding bearing corresponding to the measured rolling bearing and the radial load at the sliding matching surface 8 is the equivalent friction coefficient of the measured rolling bearing at the angular velocity; the radial load at the sliding matching surface 8 is equivalent to the radial support reaction of the measured rolling bearing; for different angular velocities ω₁, ω₂, ω₃ [symbol] . . . , establishing a binary linear equations in accordance with the constitution of the sum of the friction power of the measured rolling bearing A 22 and the measured rolling bearing B 23 under two measuring conditions in a range of a measured angular velocity:

$$\{ \begin{matrix}{F}_{1 A} {μ}_{A} ( ω ) R ω + {F}_{1 B} {μ}_{B} ( ω ) R ω = {P}_{1} ( ω ) \\ {F}_{2 A} {μ}_{A} ( ω ) R ω + {F}_{2 B} {μ}_{B} ( ω ) R ω = {P}_{2} ( ω )\end{matrix} , ω = {ω}_{1 } {ω}_{2 } {ω}_{3 } …$$

wherein, a first term on a left side of the equal sign of the equations is the friction power of the measured rolling bearing A 22, a second term is the frictional power of the measured rolling bearing B 23, and μ_{A}(ω) [symbol] μ_{B}(ω) is the numerical relationship between the equivalent friction coefficient and the angular velocity of measured rolling bearing A and measured rolling bearing B respectively; obtaining the numerical relationship between the equivalent friction coefficient and the angular velocity μ_{A}(ω), μ_{B}(ω) of measured rolling bearing A and measured rolling bearing B respectively by solving the binary linear equations above; in accordance with the mechanical relationship between the friction torque and the friction coefficient, when the radial load on the measured rolling bearing A 22 and the measured rolling bearing B 23 are F, numerical relationship M_{A}(ω) M_{B}(ω) between the equivalent friction torque and the angular velocity of the measured rolling bearing A and the measured rolling bearing B are respectively as follows:

$$\{ \begin{matrix}{M}_{A} ( ω ) = {μ}_{A} ( ω ) F R \\ {M}_{B} ( ω ) = {μ}_{B} ( ω ) F R\end{matrix} , ω = {ω}_{1 } {ω}_{2 } {ω}_{3} …$$

when the angular velocity of the mandrel 13 tends zero, the corresponding equivalent friction torque and equivalent friction coefficient are respectively equivalent to the starting equivalent friction torque and starting equivalent frictional coefficient of the measured rolling bearing A 22 and the measured rolling bearing B 23.

We claim:

1. An equivalent friction coefficient measurement apparatus for a rolling bearing, comprising: a machine body, a rotary shafting, a sliding seat, a rotational velocity sensor and a data acquisition/processing/calculation/display system, wherein the rotary shafting comprises a mandrel and two support bearings supporting the mandrel, and the rotary shafting is installed between the machine body and the sliding seat; the two support bearings are configured as air-floating spindle assemblies or measured rolling bearings or the air-floating spindle assembly and the measured rolling bearing, wherein the air-floating spindle assembly comprises an air-floating spindle base and an air-floating spindle, and the rotary shafting further comprises the measured rolling bearing when the two support bearings supporting the mandrel are air-floating spindle assemblies; the measurement apparatus further comprises a power device and a clutch device, a output shaft of the power device is configured to connect to or separate from a free end of one of the air-floating spindles through the clutch device when the two supporting bearings are air-floating spindle assemblies, or the output shaft of the power device is configured to connect to or separate from the mandrel through the clutch device when the two supporting bearings are measured rolling bearings, or the output shaft of the power device is configured to connect to or separate from the air-floating bearing spindle through the clutch device when the two supporting bearings are the air-floating spindle assembly and the measured rolling bearing; the rotational velocity sensor is configured to monitor a angular velocity of gyration of the mandrel; the data acquisition/processing/calculation/display system is configured to acquire and process the angular velocity of gyration signal of the mandrel monitored by the rotational velocity sensor, acquire a numerical relationship between the angular velocity of the mandrel and time under a condition of no power, and calculate a numerical relationship between the total kinetic energy of the rotary shafting and time, wherein a derivative with respect to time of the numerical relationship between the total kinetic energy of the rotary shafting and time at a certain moment is a friction power of the measured rolling bearing corresponding to the angular velocity at the certain moment; the data acquisition/processing/calculation/display system is configured to calculate and display an equivalent friction torque and the equivalent friction coefficient of the measured rolling bearing according to the relationship between the friction power and the equivalent frictional torque and the equivalent friction coefficient.

2. The measurement apparatus of claim 1, wherein the measured rolling bearing is an angular contact ball bearing, a thrust ball bearing or a single row tapered roller bearing, and the measured rolling bearing is abstracted as a virtual sliding bearing with a constant contact angle, and a sliding mating surface of the virtual sliding bearing is configured to pass through the center of a rolling element of the measured rolling bearing, that is, the contact angle of the virtual sliding bearing is configured to equal to the contact angle α of the measured rolling bearing, and the sliding mating surface of the virtual sliding bearing is configured to pass through the center of the rolling element of the measured rolling bearing, and an inner ring and an outer ring of the virtual sliding bearing form a sliding friction pair at the sliding mating surface; the friction power consumption of the sliding friction pair is equivalent to the friction power consumption of the measured rolling bearing when placing the virtual sliding bearing in the same measurement condition as the corresponding measured rolling bearing, and the friction power consumption of the sliding friction pair is equal to a product of a sliding friction torque of the sliding friction pair and the angular velocity of gyration of the virtual sliding bearing, wherein the sliding friction torque of the sliding friction pair is equal to a product of a radius R of a middle portion of the sliding mating surface, a normal load at the sliding mating surface and a friction coefficient of the sliding friction pair; the sliding friction torque of the sliding friction pair is referred as the equivalent friction torque of the measured rolling bearing, and the sliding friction coefficient of the sliding friction pair is referred as the equivalent friction coefficient of the measured rolling bearing.

3. The measurement apparatus of claim 1, wherein the measured rolling bearing is a deep groove ball bearing or a cylindrical roller bearing, and the measured rolling bearing is abstracted as a virtual journal sliding bearing with a sliding mating surface passing through the center of a rolling element of the measured rolling bearing, that is, the sliding mating surface of the virtual journal sliding bearing is configured to pass through the center of the rolling element of the measured rolling bearing, and an inner ring and an outer ring of the virtual journal sliding bearing form a sliding friction pair at the sliding mating surface; the friction power consumption of the sliding friction pair is equivalent to the friction power consumption of the measured rolling bearing when placing the virtual journal sliding bearing in the same measurement condition as the corresponding measured rolling bearing, and the friction power consumption of the sliding friction pair is equal to a product of a sliding friction torque of the sliding friction pair and the angular velocity of gyration of the virtual journal sliding bearing, wherein the sliding friction torque of the sliding friction pair is equal to a product of a radius R of a middle portion of the sliding mating surface, a normal load at the sliding mating surface and a friction coefficient of the sliding friction pair; the sliding friction torque of the sliding friction pair is referred as the equivalent friction torque of the measured rolling bearing, and the sliding friction coefficient of the sliding friction pair is referred as the equivalent friction coefficient of the measured rolling bearing.

4. The measurement apparatus of claim 2, wherein one of the two support bearings supporting the mandrel is the air-floating spindle assembly, while the other one is the measured rolling bearing; the air-floating spindle base is fixedly connected with the machine body, and an end of the mandrel is connected with the air-floating spindle through a conical surface or a coupling; a measured rolling bearing mounting structure is arranged between the other end of the mandrel and the sliding seat, wherein the measured rolling bearing mounting structure comprises a shaft shoulder arranged at the end of the mandrel for mounting an inner ring of the measured rolling bearing, and a bearing seat for mounting an outer ring of the measured rolling bearing is fixed on the sliding seat, wherein the bearing seat is provided with an inner cylindrical surface cooperating with an outer cylindrical surface of the outer ring of the measured rolling bearing and an outer ring retaining shoulder, and the inner cylindrical surface is coaxially arranged with the air-floating spindle, and the sliding seat is driven by an external force to translate axially along the air-floating spindle.

5. An equivalent friction coefficient measurement method for a rolling bearing, comprising: the measurement apparatus of claim 4, wherein the power device is arranged on one side of the machine body, and the output shaft of the power device is configured to connect to or separate from the free end of one of the air-floating spindle through the clutch device; an axial loading device is arranged on one side of the sliding seat, wherein the rotary shafting comprises the air-floating spindle, the mandrel, the inner ring of the measured rolling bearing, the rolling element of the measured rolling bearing and a cage of the measured rolling bearing; the measurement method further comprises:
S1: connecting one end of the mandrel with the air-floating spindle through the conical surface or the coupling, and mounting the inner ring of the measured rolling bearing to the shaft shoulder on the other end of the mandrel, moving the sliding seat to mount the outer ring of the measured rolling bearing to the outer ring retaining shoulder of the bearing seat;
S2: applying a specified axial load to the outer ring of the measured rolling bearing through the sliding seat and the bearing seat by the axial loading device according to the type and size of the measured rolling bearing and the friction torque measurement specification of rolling bearing which shall be followed;
S3: driving the air-floating spindle to rotate by the power device through the clutch device, keeping the air-floating spindle, the mandrel, the inner ring of the measured rolling bearing rotating synchronously; acquiring and processing an angular velocity signal from the rotational velocity sensor of the mandrel, and calculating and displaying the angular velocity of the mandrel by the data acquisition/processing/calculation/display system;
S4: increasing the rotation velocity of the air-floating spindle and the mandrel to a given value gradually, separating the output shaft of the power device from the air-floating spindle by the clutch device after the rotation velocity is stabilized; gradually attenuating the rotation velocity of the mandrel under the friction power consumption of the measured rolling bearing until the mandrel stops rotating; obtaining the numerical relationship between the angular velocity of the mandrel and time by the data acquisition/processing/calculation/display system;
S5: calculating a motion speed and kinetic energy of all moving parts on the rotary shafting by the data acquisition/processing/calculation/display system; obtaining a numerical relationship between the total kinetic energy of the rotary shafting and time; taking a derivative of the numerical relationship between the total kinetic energy of the rotary shafting and time, wherein the derivative with respect to time is a decreasing rate of the total kinetic energy at a certain moment, which is also the friction power of the measured rolling bearing at the corresponding angular velocity at the moment, and the quotient of the friction power of the measured rolling bearing divided by the angular velocity is the equivalent friction torque of the measured rolling bearing at the angular velocity; the quotient of the equivalent friction torque of the measured rolling bearing divided by the product of the radius R at the middle portion of the sliding mating surface of the virtual sliding bearing corresponding to the measured rolling bearing and the normal load at the sliding matching surface is the equivalent friction coefficient of the measured rolling bearing at the angular velocity; the normal load at the sliding matching surface is equivalent to the normal component of the axial load of the corresponding measured rolling at the sliding mating surface; when the angular velocity of the mandrel tends to zero, the corresponding equivalent friction torque and equivalent friction coefficient are equivalent to a starting equivalent friction torque and a starting equivalent friction coefficient of the measured rolling bearing.

6. The measurement apparatus of claim 2, wherein one of the two support bearings supporting the mandrel is the air-floating spindle assembly, while the other one is the measured rolling bearing; the air-floating spindle base is fixedly connected with the machine body, and an end of the mandrel is connected with the air-floating spindle through a conical surface or a coupling; a measured rolling bearing mounting structure is arranged between the other end of the mandrel and the sliding seat, wherein the measured rolling bearing mounting structure comprises a bearing seat arranged at a shaft shoulder of the end of the mandrel for mounting an outer ring of the measured rolling bearing, and the bearing seat is provided with an inner cylindrical surface and an outer ring retaining shoulder cooperating with an outer ring of the measured rolling bearing, wherein a loading shaft for mounting an inner ring of the measured rolling bearing is fixed on the sliding seat, the loading shaft is provided with an outer cylindrical surface and an inner ring shoulder cooperating with the inner cylindrical surface of the inner ring of the measured rolling bearing, and the outer cylindrical surface is coaxially arranged with the air-floating spindle, and the sliding seat is driven by an external force to translate axially along the air-floating spindle.

7. An equivalent friction coefficient measurement method for a rolling bearing, comprising: the measurement apparatus of claim 6, wherein the power device is arranged on one side of the machine body, and the output shaft of the power device is configured to connect to or separate from the free end of one of the air-floating spindle through the clutch device; an axial loading device is arranged on one side of the sliding seat, wherein the rotary shafting comprises the air-floating spindle, the mandrel, bearing seat, the outer ring of the measured rolling bearing, the rolling element of the measured rolling bearing and a cage of the measured rolling bearing; the measurement method further comprises:
S1: connecting one end of the mandrel with the air-floating spindle through the conical surface or the coupling, and mounting the bearing seat to the shaft shoulder of the other end of the mandrel, moving the sliding seat to mount the inner ring of the measured rolling bearing to an inner ring shoulder of the loading shaft, mounting the outer ring of the measured rolling bearing to the outer ring retaining shoulder of the bearing seat;
S2: applying a specified axial load to the inner ring of the measured rolling bearing through the sliding seat and the loading shaft by the axial loading device according to the type and size of the measured rolling bearing and the friction torque measurement specification of rolling bearing which shall be followed;
S3: driving the air-floating spindle to rotate by the power device through the clutch device, keeping the air-floating spindle, the mandrel, the bearing seat and the outer ring of the measured rolling bearing rotating synchronously; acquiring and processing an angular velocity signal from the rotational velocity sensor of the mandrel, and calculating and displaying the angular velocity of the mandrel by the data acquisition/processing/calculation/display system;
S4: increasing a rotation velocity of the air-floating spindle and the mandrel to a given value gradually, separating the output shaft of the power device from the air-floating spindle by the clutch device after the rotation velocity is stabilized; gradually attenuating the rotation velocity of the mandrel under the action of the friction power consumption of the measured rolling bearing until the mandrel stops rotating; obtaining the numerical relationship between the angular velocity of the mandrel and time by the data acquisition/processing/calculation/display system;
S5: calculating a motion speed and kinetic energy of all moving parts on the rotary shafting by the data acquisition/processing/calculation/display system; obtaining a numerical relationship between the total kinetic energy of the rotary shafting and time; taking a derivative of the numerical relationship between the total kinetic energy of the rotary shafting and time, wherein the derivative with respect to time is a decreasing rate of the total kinetic energy at a certain moment, which is also the friction power of the measured rolling bearing at the corresponding angular velocity at the moment, and the quotient of the friction power of the measured rolling bearing divided by the angular velocity is the equivalent friction torque of the measured rolling bearing at the angular velocity; the quotient of the equivalent friction torque of the measured rolling bearing divided by the product of the radius R at the middle portion of the sliding mating surface of the virtual sliding bearing corresponding to the measured rolling bearing and the normal load at the sliding matching surface is the equivalent friction coefficient of the measured rolling bearing at the angular velocity; the normal load at the sliding matching surface is equivalent to the normal component of the axial load of the corresponding measured rolling at the sliding mating surface; when the angular velocity of the mandrel tends to zero, the corresponding equivalent friction torque and equivalent friction coefficient are equivalent to a starting equivalent friction torque and a starting equivalent friction coefficient of the measured rolling bearing.

8. The measurement apparatus of claim 2, wherein the two support bearings supporting the mandrel are all measured rolling bearings and respectively referred to as measured rolling bearing A and measured rolling bearing B; two ends of the mandrel are respectively provided with a shaft shoulder for mounting the inner ring of the measured rolling bearing A and the measured rolling bearings B; two bearing seats, wherein one of the two bearing seats is fixedly connected to the machine body, and the other one is fixedly connected with the sliding seat; the two bearing seats are respectively provided with an outer ring shaft shoulder and an inner cylindrical surface for mounting the measured rolling bearing A and the measured rolling bearings B; the inner cylindrical surfaces of the two bearing seats are coaxially arranged, and the sliding seat is driven by an external force to translate axially along the inner cylindrical surfaces of the bearing seats; the two bearing seats are arranged vertically, and axes of the inner cylindrical surfaces of the two bearing seats are perpendicular to a horizontal plane; the equivalent friction coefficient measurement apparatus for the rolling bearing is applicable to the measurement of the equivalent friction coefficient for the angular contact ball bearing or the single row tapered roller bearing.

9. An equivalent friction coefficient measurement method for a rolling bearing, comprising: the measurement apparatus of claim 8, wherein the power device is arranged on one side of the machine body, and the output shaft of the power device is configured to connect to or separate from the mandrel through the clutch device; an axial loading device is arranged on one side of the sliding seat, wherein the rotary shafting comprises the mandrel, the inner ring of the measured rolling bearing A, the inner ring of the measured rolling bearing B, the rolling element of the measured rolling bearing A, the rolling element of the measured rolling bearing B, a cage of the measured rolling bearing A and a cage of the measured rolling bearing B; the measurement method further comprises:
S1: respectively mounting the inner ring of the measured rolling bearing A and the inner ring of the measured rolling bearing B to shaft shoulders on two ends of mandrel; moving the sliding seat to mount the outer ring of the measured rolling bearing A to an outer ring retaining shoulder fixedly connected to the machine body, and the outer ring of the measured rolling bearing B to the outer ring retaining shoulder of the bearing seat fixedly connected to the sliding seat;
S2: applying a specified axial load F₁ to the outer ring of the measured rolling bearing B through the sliding seat and the bearing seat fixedly connected to the sliding seat by the axial loading device according to the type and size of the measured rolling bearing and the friction torque measurement specification of rolling bearing which shall be followed;
S3: driving the mandrel to rotate by the power device through the clutch device, keeping the mandrel, the inner ring of the measured rolling bearing A and the inner ring of the measured rolling bearing B rotating synchronously; acquiring and processing an angular velocity signal from the rotational velocity sensor of the mandrel, and calculating and displaying the angular velocity of the mandrel by the data acquisition/processing/calculation/display system;
S4: increasing the rotation velocity of the mandrel to a given value gradually; separating the output shaft of the power device from the mandrel by the clutch device after the rotation velocity is stabilized; gradually attenuating the rotation velocity of the mandrel under the action of the friction power consumption of the measured rolling bearing A and the measured rolling bearing B until the mandrel stops rotating; obtaining the numerical relationship ω(t) between the angular velocity of the mandrel and time by the data acquisition/processing/calculation/display system;
S5: calculating a motion speed and kinetic energy of all moving parts on the rotary shafting by the data acquisition/processing/calculation/display system; obtaining a numerical relationship between the total kinetic energy of the rotary shafting and time; taking a derivative of the numerical relationship between the total kinetic energy of the rotary shafting and time, wherein the derivative with respect to time is a decreasing rate of the total kinetic energy at a certain moment t, which is also a sum of the friction powers of the measured rolling bearing A and the measured rolling bearing B at the corresponding angular velocity at the moment, thus obtaining a numerical relationship P₁(ω) of the sum of the friction powers of the measured rolling bearing A and the measured rolling bearing B and the angular velocity;
S6: respectively mounting the inner ring of the measured rolling bearing A and the inner ring of the measured rolling bearing B to shaft shoulders on two ends of mandrel; moving the sliding seat to mount the outer ring of the measured rolling bearing B to an outer ring retaining shoulder fixedly connected to the machine body, and the outer ring of the measured rolling bearing A to the outer ring retaining shoulder of the bearing seat fixedly connected to the sliding seat;
S7: applying a specified axial load F₂ to the outer ring of the measured rolling bearing A through the sliding seat and the bearing seat fixedly connected to the sliding seat by the axial loading device according to the type and size of the measured rolling bearing and the friction torque measurement specification of rolling bearing which shall be followed;
S8: repeating the step S3, S4, S5, and obtaining the numerical relationship ω(t) between the angular velocity of the mandrel and the time, the numerical relationship between the total kinetic energy of the rotary shafting and time, and obtaining a numerical relationship P₂(ω) of the sum of the friction powers of the measured rolling bearing A and the measured rolling bearing B and the angular velocity by the data acquisition/processing/calculation/display system;
S9: the quotient of the friction power of the measured rolling bearing divided by a angular velocity of gyration of the measured rolling bearing is the equivalent friction torque of the measured rolling bearing at the angular velocity; the quotient of the equivalent friction torque of the measured rolling bearing divided by the product of the radius R at the middle portion of the sliding mating surface of the virtual sliding bearing corresponding to the measured rolling bearing and the normal load at the sliding matching surface is the equivalent friction coefficient of the measured rolling bearing at the angular velocity; the normal load at the sliding matching surface is equivalent to the normal component of an axial load of the corresponding measured rolling bearing at the sliding mating surface, which is a quotient of an axial load on the measured rolling bearing divided by the sine of a contact angle α of the measured rolling bearing; establishing a binary linear equations in accordance with the constitution of the sum of the friction power of the measured rolling bearing A and the measured rolling bearing B under two measuring conditions in a range of a measured angular velocity for different angular velocities ω₁, ω₂, ω₃ [symbol] . . . ,
$$\{ \begin{matrix}\frac{{F}_{1} + G}{sin α} {μ}_{A} ( ω ) R ω + \frac{{F}_{1}}{sin α} {μ}_{B} ( ω ) R ω = {P}_{1} ( ω ) \\ \frac{{F}_{2}}{sin α} {μ}_{A} ( ω ) R ω + \frac{{F}_{2} + G}{sin α} {μ}_{B} ( ω ) R ω = {P}_{2} ( ω )\end{matrix} , ω = {ω}_{1} {ω}_{2} {ω}_{3} . . .$$
wherein, a first term on a left side of the equal sign of the equations is the friction power of the measured rolling bearing A, a second term is the frictional power of the measured rolling bearing B, and G is the gravity of the mandrel, μ_{A}(ω) [symbol] μ_{B}(ω) is the numerical relationship between the equivalent friction coefficient and the angular velocity of measured rolling bearing A and measured rolling bearing B respectively; obtaining the numerical relationship between the equivalent friction coefficient and the angular velocity μ_{A}(ω), μ_{B}(ω) of measured rolling bearing A and measured rolling bearing B respectively by solving the binary linear equations above; in accordance with the mechanical relationship between the friction torque and the friction coefficient, when the axial load on the measured rolling bearing A and the measured rolling bearing B are F, numerical relationship M_{A}(ω), M_{B}(ω) between the equivalent friction torque and the angular velocity of the measured rolling bearing A and the measured rolling bearing B are respectively as follows:
$$\{ \begin{matrix}{M}_{A} ( ω ) = \frac{{μ}_{A} ( ω ) F R}{sin α} \\ {M}_{B} ( ω ) = \frac{{μ}_{B} ( ω ) F R}{sin α}\end{matrix} , ω = {ω}_{1} {ω}_{2} {ω}_{3} . . .$$
when the angular velocity of the mandrel tends zero, the corresponding equivalent friction torque and equivalent friction coefficient are respectively equivalent to the starting equivalent friction torque and starting equivalent frictional coefficient of the measured rolling bearing A and the measured rolling bearing B.

10. The measurement apparatus of claim 3, wherein the two support bearings supporting the mandrel are all the air-floating spindle assembly, and the two air-floating spindles are coaxially arranged; one of the air-floating spindle bases is fixedly connected with the machine body, while the other one is fixedly connected with the sliding seat; both ends of the mandrel are respectively connected with the two air-floating spindles through a conical surface or a coupling, and the mandrel is coaxially arranged with the two air-floating spindles; the mandrel is provided with a shaft shoulder for mounting an inner ring of the measured rolling bearing, and the sliding seat is driven by an external force to translate axially along the air-floating spindle.

11. An equivalent friction coefficient measurement method for a rolling bearing, comprising: the measurement apparatus of claim 10, comprising: the output shaft of the power device is connected to or separated from a free end of one of the air-floating spindles through the clutch device, and a radial loading device is arranged radially along the measured rolling bearing; wherein the rotary shafting comprises the two air-floating spindles, the mandrel, an inner ring of the measured rolling bearing, a rolling element and a cage of the measured rolling bearing; the measurement method further comprises:
S1: mounting the inner ring of the measured rolling bearing on the shaft shoulder (14) of the mandrel (13); connecting the both ends of the mandrel to the two air-floating spindles respectively through the conical surface or the coupling;
S2: applying a specified radial load to the outer ring of the measured rolling bearing through the radial loading device according to the type and size of the measured rolling bearing and the friction torque measurement specification of rolling bearing which shall be followed;
S3: driving the mandrel to rotate by the power device through the clutch device; keeping the air-floating spindle, the mandrel and the inner ring of the measured rolling bearing rotating synchronously; acquiring and processing an angular velocity signal from the rotational velocity sensor of the mandrel, and calculating and displaying the angular velocity of the mandrel by the data acquisition/processing/calculation/display system;
S4: increasing the rotation velocity of the air-floating spindle and the mandrel to a given value gradually; separating the output shaft of the power device from the air-floating by the clutch device after the rotation velocity is stabilized; gradually attenuating the rotation velocity of the mandrel under the action of the friction power consumption of the measured rolling bearing until the mandrel stops rotating; obtaining the numerical relationship between the angular velocity of the mandrel and the time by the data acquisition/processing/calculation/display system;
S5: calculating a motion speed and kinetic energy of all moving parts on the rotary shafting by the data acquisition/processing/calculation/display system; obtaining a numerical relationship between the total kinetic energy of the rotary shafting and time; taking a derivative of the numerical relationship between the total kinetic energy of the rotary shafting and time, wherein the derivative with respect to time is a decreasing rate of the total kinetic energy at a certain moment, which is also the friction power of the measured rolling bearing at the corresponding angular velocity at the moment, and the quotient of the friction power of the measured rolling bearing divided by the angular velocity is the equivalent friction torque of the measured rolling bearing at the angular velocity; the quotient of the equivalent friction torque of the measured rolling bearing divided by the product of the radius R at the sliding mating surface of a virtual journal sliding bearing corresponding to the measured rolling bearing and the radial load at the sliding matching surface is the equivalent friction coefficient of the measured rolling bearing at the angular velocity; when the angular velocity of the mandrel tends to zero, the corresponding equivalent friction torque and equivalent friction coefficient are equivalent to a starting equivalent friction torque and a starting equivalent friction coefficient of the measured rolling bearing.

12. The measurement apparatus of claim 3, wherein the two support bearings supporting the mandrel are all measured rolling bearings and respectively referred to as measured rolling bearing A and measured rolling bearing B; two ends of the mandrel are respectively provided with a shaft shoulder for mounting the inner ring of the measured rolling bearing A and the measured rolling bearings B; two bearing seats, wherein one of the two bearing seats is fixedly connected to the machine body, and the other one is fixedly connected with the sliding seat; the two bearing seats are respectively provided with an inner cylindrical surface cooperating with an outer cylindrical surface of the outer ring of the measured rolling bearing A and the measured rolling bearings B; the inner cylindrical surfaces of the two bearing seats are coaxially arranged; the mandrel is provided with a ring-shaped counterweight; the sliding seat is driven by an external force to translate axially along the inner cylindrical surfaces of the bearing seats; the two bearing seats are arranged horizontally, and the axes of the inner cylindrical surfaces of the two seats are parallel to a horizontal plane.

13. An equivalent friction coefficient measurement method for a rolling bearing, comprising: the measurement apparatus of claim 12, wherein the output shaft of the power device is configured to connect to or separate from a free end of the mandrel through the clutch device; wherein the rotary shafting comprises the mandrel, the inner ring of the measured rolling bearing A, the inner ring of the measured rolling bearing B, the rolling element of the measured rolling bearing A, the rolling element of the measured rolling bearing B, a cage of the measured rolling bearing A, a cage of the measured rolling bearing B and the ring-shaped counterweight; the measurement method further comprises:
S1: respectively mounting the inner ring of the measured rolling bearing A and the inner ring of the measured rolling bearing B to shaft shoulders on two ends of mandrel; moving the sliding seat to mount the outer ring of the measured rolling bearing A and the measured rolling bearing B to the inner cylindrical surface of the two bearing seats;
S2: adjusting a mass and an axial position on the mandrel of the ring-shaped counterweight according to the type and size of the measured rolling bearing, wherein the radial support reaction of the measured rolling bearing A and the measured rolling bearing B are F_{1A} and F_{1B} respectively and meet the requirements of the friction torque measurement specification of the rolling bearing for applying radial load;
S3: driving the mandrel to rotate by the power device through the clutch device, keeping the mandrel, the inner ring of the measured rolling bearing A, the inner ring of the measured rolling bearing B and the ring-shaped counterweight rotating synchronously; acquiring and processing an angular velocity signal from the rotational velocity sensor of the mandrel, and calculating and displaying the angular velocity of the mandrel by the data acquisition/processing/calculation/display system;
S4: increasing the rotation velocity of the mandrel to a given value gradually; separating the output shaft of the power device from the mandrel by the clutch device after the rotation velocity is stabilized; gradually attenuating the rotation velocity of the mandrel under the action of the friction power consumption of the measured rolling bearing A and the measured rolling bearing B until the mandrel stops rotating; obtaining the numerical relationship ω(t) between the angular velocity of the mandrel and time by the data acquisition/processing/calculation/display system;
S5: calculating a motion speed and kinetic energy of all moving parts on the rotary shafting by the data acquisition/processing/calculation/display system; obtaining a numerical relationship between the total kinetic energy of the rotary shafting and time; taking a derivative of the numerical relationship between the total kinetic energy of the rotary shafting and time, wherein the derivative with respect to time is a decreasing rate of the total kinetic energy at a certain moment, which is also the friction powers of the measured rolling bearing at the corresponding angular velocity at the moment, thus obtaining a numerical relationship P₁(ω) of the sum of the friction powers of the measured rolling bearing A and the measured rolling bearing B and the angular velocity;
S6: adjusting a mass and an axial position on the mandrel of the ring-shaped counterweight according to the type and size of the measured rolling bearing, wherein the radial support reaction of the measured rolling bearing A and the measured rolling bearing B are F_{2A} and F_{2B} respectively and meet the requirements of the friction torque measurement specification of the rolling bearing for applying radial load, wherein the F_{2A}, F_{2B} and F_{1A}, F_{1B} are linearly independent;
S7: repeating the step S3, S4, S5, and obtaining the numerical relationship ω(t) between the angular velocity of the mandrel and the time in real time, the numerical relationship between the total kinetic energy of the rotary shafting and time, and obtaining a numerical relationship P₂(ω) of the sum of the friction powers of the measured rolling bearing A and the measured rolling bearing B and the angular velocity by the data acquisition/processing/calculation/display system;
S8: the quotient of the friction power of the measured rolling bearing divided by a angular velocity of gyration of the measured rolling bearing is the equivalent friction torque of the measured rolling bearing at the angular velocity; the quotient of the equivalent friction torque of the measured rolling bearing divided by the product of the radius R of the sliding mating surface of the virtual journal sliding bearing corresponding to the measured rolling bearing and the radial load at the sliding matching surface is the equivalent friction coefficient of the measured rolling bearing at the angular velocity; the radial load at the sliding matching surface is equivalent to the radial support reaction of the measured rolling bearing; for different angular velocities ω₁, ω₂, ω₃ [symbol] . . . , establishing a binary linear equations in accordance with the constitution of the sum of the friction power of the measured rolling bearing A and the measured rolling bearing B under two measuring conditions in a range of a measured angular velocity:
$$\{ \begin{matrix}{F}_{1 A} {μ}_{A} ( ω ) Rω + {F}_{1 B} {μ}_{B} ( ω ) Rω = {P}_{1} ( ω ) \\ {F}_{2 A} {μ}_{A} ( ω ) Rω + {F}_{2 B} {μ}_{B} ( ω ) Rω = {P}_{2} ( ω )\end{matrix} , ω = {ω}_{1} {ω}_{2} {ω}_{3} . . .$$
wherein, a first term on a left side of the equal sign of the equations is the friction power of the measured rolling bearing A, a second term is the frictional power of the measured rolling bearing B, and μ_{A}(ω) [symbol] μ_{B}(ω) is the numerical relationship between the equivalent friction coefficient and the angular velocity of measured rolling bearing A and measured rolling bearing B respectively; obtaining the numerical relationship between the equivalent friction coefficient and the angular velocity μ_{A}(ω), μ_{B}(ω) of measured rolling bearing A and measured rolling bearing B respectively by solving the binary linear equations above; in accordance with the mechanical relationship between the friction torque and the friction coefficient, when the radial load on the measured rolling bearing A and the measured rolling bearing B are F, numerical relationship M_{A}(ω), M_{B}(ω) between the equivalent friction torque and the angular velocity of the measured rolling bearing A and the measured rolling bearing B are respectively as follows:
$$\{ \begin{matrix}{M}_{A} ( ω ) = {μ}_{A} ( ω ) FR \\ {M}_{B} ( ω ) = {μ}_{B} ( ω ) F R\end{matrix} , {ω}_{1 } {ω}_{2} {ω}_{3 } …$$
when the angular velocity of the mandrel tends zero, the corresponding equivalent friction torque and equivalent friction coefficient are respectively equivalent to the starting equivalent friction torque and starting equivalent frictional coefficient of the measured rolling bearing A and the measured rolling bearing B.
